(19) United States
(12) Patent Application Publication
(10) Pub. No.: US 2010/0289206 A1
(43) Pub. Date: Nov. 18, 2010

(54) RECORDING APPARATUS

(75) Inventors: Satoshi YOSHINO, Shiojiri-shi (JP); Tetsuya MIYAGAWA, Shiojiri-shi (JP); Kazumasa HARADA, Matsumoto-shi (JP); Hidetoshi KODAMA, Matsumoto-shi (JP)

Correspondence Address: WORKMAN NYDEGGER;1000 Eagle Gate Tower, 60 East South Temple, Salt Lake City, UT, 84111, US

(73) Assignee: Seiko Epson Corporation, Tokyo (JP)

(21) Appl. No.: 12/779,332

(22) Filed: May 13, 2010

(30) Foreign Application Priority Data
May 13, 2009 (JP) 2009-116383

(51) Int. Cl. B65H 31/00; F16H 19/08

(52) U.S. Cl. 271/3.14; 74/89.18

(57) ABSTRACT

A recording apparatus including a stacker which is configured to be displaced between a first posture for stacking a recording medium in an inclined state that a first end part which is distant from a recording position in a transport direction is located above a second end part which is near thereto, and a second posture for forming a transporting path of a straight line along which the recording medium is able to be transported toward the recording position; a first support unit which supports the first end part of the stacker to be able to rotate; and a second support unit which moves the second end part of the stacker upward and downward while supporting the second end part of the stacker to rotate the stacker centering around the first end part when the stacker is displaced between the first posture and the second posture.

### BACKGROUND

1. Technical Field

The present invention relates to a recording apparatus which includes a stacker for stacking a recording medium (flexible recording medium) such as printing paper discharged after completion of printing, the stacker being configured to change its posture so that the stacker serves as a feed guiding surface for feeding a recording medium (hard recording medium) such as an optical disc.

2. Related Art

In a printer which is a kind of recording apparatus, a stacker for stacking printing paper or the like (recording medium) after completion of printing is provided in a paper discharging port. The stacker is arranged in an inclined manner so that a front end part thereof on a downstream side in a transport direction is located higher than a base end part thereof. The printing paper or the like is stacked on the inclined stacker. Further, for example, in JP-A-2007-45574 (for example, FIGS. 11 to 13 or the like), JP-A-2007-45573, JP-A-2008-238826, and JP-A-2004-130774, a printer is disclosed which is capable of printing a label on a disc such as a CDR. In such a printer, an inclined posture of a stacker is changed into a horizontal posture in which an upper surface (recording medium stacking surface) of the stacker has the same height as an upper surface (transport surface) of a platen, by manipulation of a manipulation lever. A disc hold tray which holds the disc is set on the upper surface of the stacker in the horizontal posture and then is fed inside of the printer. Thereafter, the label printing is performed on the disc by means of a recording head while the disc is being fed to a downstream side in a transporting direction.

In this way, the stacker disclosed in JP-A-2007-45574 (for example, FIGS. 11 to 13 or the like) can change its postures in the printing on the printing paper and in the label printing by the manipulation of the manipulation lever.

In the stacker disclosed in JP-A-2007-45574 (for example, FIGS. 11 to 13 or the like), for example, when the stacker changes its posture from the printing in the printing paper to the label printing, force of the manipulation lever acts on a base end part of the stacker, and thus, a front end part thereof rotates to move upwards with the base end part being a supporting point. When the front end part of the stacker rotates up to a predetermined position, engagement with the supporting point of the base end part is released. Thereafter, the base end part of the stacker is displaced upwards and the front end part thereof moves downwards, and thus, the stacker is finally arranged in the horizontal posture.

However, in the stacker disclosed in JP-A-2007-45574 (for example, FIGS. 11 to 13 or the like), in the posture changing process, the front end part of the stacker should rotate to significantly move upwards with the base end part thereof being the supporting point, and then, the raised front end part should move downwards, to finally make the stacker in the horizontal posture. Thus, a movement range of the stacker is large during the posture changing process. As the movement range of the stacker is large, the printer should be of a large size to secure a space corresponding to the movement range.

### SUMMARY

An advantage of some aspects of the invention is to provide a recording apparatus which is capable of minimizing a movement range of a stacker which is necessary for changing a posture of the stacker between a first posture in which a recording medium is stacked on the stacker and a second posture which forms a path for transporting the recording medium towards a recording position in a straight line.

According to an aspect of the present invention, there is provided a recording apparatus including a transport unit which transports a recording medium and a recording unit which performs recording on the recording medium transported to a recording position. The recording apparatus includes: a stacker which is configured to be displaced between a first posture for stacking the recording medium in an inclined state that a first end part which is distant from the recording position in a transport direction is located above a second end part which is near thereto, and a second posture for forming a transporting path of a straight line shape capable of transporting the recording medium toward the recording position; a first support unit which supports the first end part of the stacker to be able to rotate; and a second support unit which moves the second end part of the stacker upward and downward while supporting the second end part of the stacker to rotate the stacker centering around the first end part when the stacker is displaced between the first posture and the second posture. In this respect, the second support unit may have any movement path as long as the second end part of the stacker can move upward and downward at different heights. That is, the movement path of the second support unit is not limited to an upward and downward direction, and thus, the second support unit may have a movement path inclined with respect to the upward and downward direction or a circular arc movement path.

According to this aspect of the present invention, in the state that the stacker is arranged in the first posture, for example, a recording medium which is supplied from a position different from the stacker, recorded and then discharged, is stacked on the stacker in the inclined posture. On the other hand, in the state that the stacker is arranged in the second posture, a transporting path of a straight line shape is formed along which the recording medium is able to be transported toward the recording position. Thus, a recording medium (for example, a hard recording medium such as a disc or a disc which is set in a tray or the like) can be fed toward the recording position with the stacker being a transport guide surface. Further, the stacker rotates with the first end part being the supporting point as the second support unit moves upward and downward while supporting the second end part with the first end part (a support position which is supported by the first support unit so that it is able to rotate) being the supporting point, and thus, is arranged in the first posture and the second posture. In this way, the stacker rotates with the first end part being supporting point to change its posture, and thus, a movement range of the stacker which is necessary for changing the posture of the stacker between the first posture and the second posture can be minimized, and thus, the recording apparatus can be prevented from being of a large size due to a relatively large movement range according to the posture change of the stacker.

According to another aspect of the present invention, the second support unit may include a support shaft which is inserted in a cut-out section which is provided in the second end part of the stacker to be relatively displaced in a rotational radius direction of the stacker, and a guide unit which guides the support shaft in a movement path in which the support shaft is displaced upward and downward. Here, the guide unit may include, in the state that the stacker is arranged in at least one posture of the first posture and the second posture, a regulating surface which regulates one movement among the upward and downward movements of the support shaft, by which the stacker is able to change its posture. Here, the regulating surface may include at least one of a regulating surface for regulating the upward movement of the support shaft when the stacker is arranged in the first posture, and a regulating surface for regulating the downward movement of the support shaft when the stacker is arranged in the second posture.

According to this aspect of the invention, as the support shaft which is inserted in the cut-out section of the second end part is guided to the guide unit and displaced upward and downward, the second end part moves upward and downward and the stacker rotates with the first end part being the supporting point. According to the rotation, the stacker can be arranged in the first posture and the second posture. In the state that the stacker is arranged in at least one posture of the first posture and the second posture, as the support shaft is in contact with the regulating surface of the guide unit, one movement among the upward and downward movements of the support shaft is regulated, by which the stacker is able to be changed to the other posture thereof. Accordingly, due to the weight of the recording medium stacked on the stacker, the weight of the stacker itself or the like, deviation of the posture of the arranged stacker can be prevented without installing a specific posture maintaining mechanism (for example, a biasing mechanism), thereby maintaining the arranged posture of the stacker. Further, the guide unit includes a first guide unit which displaces the support shaft upward and downward and a second guide unit which guides the support shaft in a path along the regulating surface. In this case, even though a guiding path of the guide unit does not necessarily coincide with a rotation trace in the second end part of the stacker, the support shaft may be relatively displaced inside of the cut-out section in the rotational radial direction of the stacker in the rotation process of the stacker, and thus the movement path may move along the guiding path of the guide unit (the first guide unit and the second guide unit).

According to another aspect of the present invention, a horizontal U-shaped guide hole may be provided as the guide unit, and the support shaft may be movably inserted into one pair of the guide holes in the opposite sides thereof with the stacker being interposed therebetween, and a pair of pinions which is engaged with a pair of racks installed along the one pair of guide holes may be installed and fixed to the opposite sides of the support shaft. Further, one side of the opposite sides of the support shaft to which the one pair of pinions is installed may be a drive side to which power for moving the support shaft upward and downward is input, and the other side thereof may be a driven side which moves upward and downward, as the pinion which is installed on an axial opposite side of the support shaft is rotated by rotation of the other pinion of the drive side.

According to this aspect of the invention, as power is input to the drive side of opposite sides of the support shaft in an axial direction, the drive side of the support shaft moves while being guided to the guide hole. At this time, the pinion of the drive side is engaged with the rack for rotating. As the rotation of the pinion of the drive side is transmitted through the support shaft, the pinion of the driven side rotates. Further, as the pinion of the driven side moves upward and downward while being engaged with the rack by the rotation, the support shaft moves upward and downward in the driven side. In this stacker, the supporting point and a force acting point when changing its position are relatively separated each other and power to be applied to the force acting point is small. Accordingly, even though the rotation of the pinion of the drive side is transmitted to the pinion of the driven side through the support shaft, there is hardly any deviation of the rotation of the pinion generated in the opposite sides of the support shaft and there is hardly any height deviation generated in the opposite sides of the support shaft. As a result, the stacker may change its posture while maintaining the same height in the opposite sides of the second end part. Further, since the guide hole has a horizontal U-shape, in the state that the stacker is arranged in one of the first posture and the second posture, one movement among the upward and downward movements of the support shaft, by which the stacker is able to change its posture, is regulated with the support shaft being in contact with the regulating surface of the support shaft. Accordingly, even though the weight of the recording medium, which is stacked in the downstream side in the transport direction from the supporting point of the stacker which is arranged in the first posture, and a rotational force (load) in a rotation direction which displaces the second end part upward is applied to the stacker, the upward movement of the support shaft is regulated with the support shaft being in contact with the regulating surface (upper wall surface) of the guide hole, thereby maintaining the stacker in the first posture. On the other hand, even though a rotational force (load) in the rotation direction which displaces the second end part downward is applied to the stacker due to the weight of the stacker which is arranged in the second posture, the downward movement of the support shaft is regulated with the support shaft being in contact with the regulating surface (lower wall surface) of the guide hole, thereby maintaining the stacker in the second posture.

According to another aspect of the invention, the recording apparatus may further include a power transmission mechanism including at least one gear which is engaged with a tooth section formed in an end edge of a manipulation lever, and the power transmission mechanism may increase the speed of the power transmitted to the tooth section on the basis of a manipulation force of the manipulation lever and transmit the speed increased power to the support shaft.

According to this aspect of the invention, as the manipulation force of the manipulation lever is transmitted to the support shaft through the power transmission mechanism, the support shaft is guided to the guide hole and then is displaced upward and downward, and thus, the posture of the stacker is changed. At this time, the power transmitted to the tooth section on the basis of the manipulation force of the manipulation lever is speed-increased by the power transmission mechanism and is transmitted to the support shaft. Accordingly, even though the guide hole is the horizontal U-shape and the movement path of the support shaft is relatively long, the amount of the manipulation of the manipulation lever may be decreased. As a result, for example, the recording apparatus can be prevented from being of a large size due to a relatively large movement range of the manipulation lever. Further, since the supporting point and the force acting point of the stacker are separate from each other and the power to be applied to the force acting point (support shaft) is relatively small, it is possible to easily manipulate the manipulation lever, even though manipulation force is speed-increased through the power transmission mechanism.

According to another aspect of the invention, a locking recess which is recessed in a direction crossing an extending direction of the cut-out section may be formed in an inner circumferential edge of the cut-out section, and in the state that the stacker is arranged in at least one of the first posture and the second posture, the support shaft may be positioned in the state of being locked to the locking recess.

According to this aspect of the invention, in the state that the stacker is arranged in at least one of the first posture and the second posture, the support shaft which is inserted in the cut-out section is positioned in the state of being locked to the locking recess. Accordingly, the support shaft does not move to a side in which there is no regulating surface, but contact with the regulating surface is maintained. Thus, the stacker may be further effectively maintained in the currently arranged posture, among the first posture and the second posture.

According to another aspect of the invention, the stacker may have a slide configuration of a plurality of stages, which is capable of being extended, and the first end part may be supported to relatively move toward and away from the first support unit and to be able to rotate.

According to this aspect of the invention, as the first end part of the stacker is displaced in a direction in which the first end part of the stacker is separated from the first support unit, a gap which is required to insert fingers when sliding the stacker may be secured between the first end part and the first support unit. Further, in the state that the first end part of the stacker is located in the vicinity of the first support unit, the gap between them is narrow, to thereby easily prevent entrance of alien substances through the gap.

According to another aspect of the invention, a pair of wall sections may extend from opposite surfaces of the stacker and the first support unit, and in the state that the first end part is located adjacent to the first support unit, front end parts of the one pair of wall sections may partly overlap with each other to move toward and away from each other.

According to this aspect of the invention, in the state that the first end part of the stacker is located in the vicinity of the first support unit, the front end parts of the pair of wall sections may partly overlap with each other to move toward and away from each other. Accordingly, even though the first end part is separated from the first support unit and the gap between them is widened, the gap between the pair of wall sections in a direction in which the pair of wall sections may move toward and away from each other is not generated or is very narrow. Thus, entrance of alien substances may be further effectively prevented through the gap when is widened.

According to an another aspect of the invention, the horizontal U-shaped guide hole may be arranged to be convex toward the manipulation lever, and the pinions may be installed to be displaced in a rotation displacement direction in a position in which the pinions are deviated toward the manipulation lever from a rotation center of a rotational body which forms the power transmission mechanism with respect to the rotational body while changing the posture of the stacker.

According to this aspect of the invention, an upward and downward movement space of the support shaft, which is guided and moved in the horizontal U-shaped guide hole and is moved may be secured in the manipulation lever side in the transport direction with respect to the arrangement position of the support shaft when the stacker is arranged in each posture. Accordingly, the arrangement position of the stacker may be close to the recording unit side (for example, such as a platen which regulates the transport surface), and thus, the recording apparatus may be easily prevented from being of a large size in the transport direction. If the horizontal U-shaped guide hole is arranged to be convex toward an opposite side to the manipulation lever, in order to secure the upward and downward movement space of the support shaft without interference with other component members such as a platen for forming the transporting surface located under the recording unit, it is necessary to separate the arrangement position of the stacker from the other component members such as a platen. However, with the direction of the guide hole of the invention, the movement space in which the support shaft moves upward and downward may use a space under the stacker, the arrangement position of the stacker may be close to the other component members such as a platen.

### BRIEF DESCRIPTION OF THE DRAWINGS

The invention will be described with reference to the accompanying drawings, wherein like numbers reference like elements.

FIG. 1 is a perspective view of a printer according to an embodiment of the invention.

FIG. 2 is a perspective view of main components of the printer in the state that a stacker is located in a first position.

FIG. 3 is a perspective view of main components of the printer in the state that the stacker is located in a second position.

FIG. 4 is a perspective view of a printing unit.

FIG. 5 is a perspective view of a stacker unit in the state that the stacker is located in the first position.

FIG. 6 is a perspective view of the stacker unit in the state that the stacker is located in the second position.

FIG. 7 is a right side view of the stacker unit which is located in the first position.

FIG. 8 is a right side view of the stacker unit which is located in the second position.

FIG. 9 is a right side view of the stacker unit in the state that a part of components of a power transmission gear mechanism is removed.

FIG. 10 is a side view illustrating an installation configuration of a pinion with respect to a rotation cam.

FIG. 11 is a left side view of the stacker which is located in the first position.

FIG. 12 is a left side view of the stacker which is located in the second position.

FIG. 13 is a left side view of the stacker which is located in the first position.

FIG. 14 is a left side view of the stacker which is located in the second position.

FIG. 15 is a side view of a second support member.

FIG. 16 is a side view illustrating an elongated hole of a base end part of the stacker.

FIG. 17 is a left side view of the stacker which is located in the first position.

FIG. 18 is a left side view illustrating the stacker in the state that a front end part of the stacker is displaced upward.

FIG. 19 is a side section view of the stacker.

FIG. 20 is a perspective view illustrating the leading end part of the stacker.

FIG. 21 is a side view illustrating a cover in a closed state and a manipulation lever.

FIG. 22 is a side view illustrating the cover in an open state and a manipulation lever.

### DESCRIPTION OF EXEMPLARY EMBODIMENTS

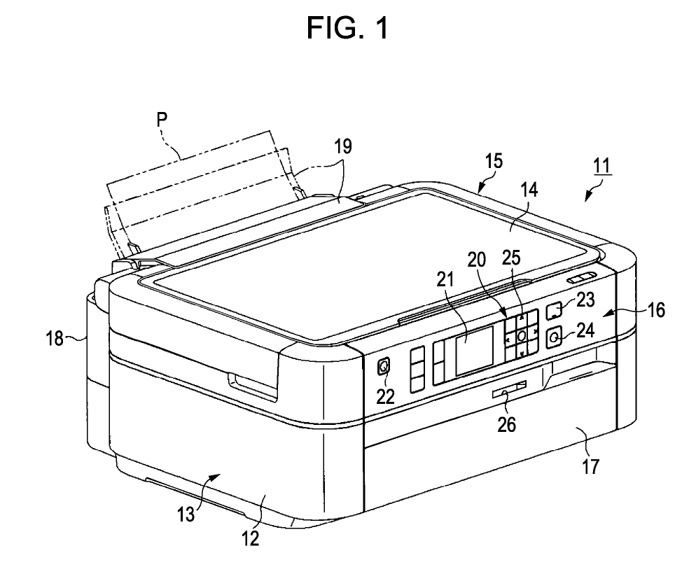

Hereinafter, an embodiment according to the invention which is specified as a multi-functional printer of an inkjet type which is a kind of recording apparatus will be described with reference to FIGS. 1 to 22.

As shown in FIG. 1, the multi-functional printer (hereinafter, referred to as a “printer 11”) is an ink jet typed color printer having three functions, that is, scanning, printing, and copying. The printer 11 includes a main body 12 of an approximately rectangular box shape. The main body 12 includes a printer unit 13 which is installed at a lower part thereof and performs printing (recording) on a recording medium such as printing paper P, and a scanner unit 15 which is installed at an upper part thereof and has an upper surface which is opened and closed by an original document cover 14. Further, a manipulation panel 16 is installed on a front upper surface of the main body 12, and a cover 17 is installed to be opened and closed under the manipulation panel 16.

The scanner 15 is used for reading (scanning) an original document set on an original document plate (not shown) under the original document cover 14. The printer unit 13 may use a flexible recording medium such as printing paper or a film (hereinafter, referred to as a “flexible recording medium”), and a hard recording medium such as a disc (optical disc or magnetic disc) such as a CDR or a DVD (hereinafter, referred to as a “hard recording medium”), as a recording medium. The flexible recording medium may include film, fabric or the like. In addition, the hard recording medium may include a cardboard, a plate or the like.

The main body 12 is provided with a paper feeder 18 (auto paper feeder) in a rear part thereof. If a rotary tray feed 19 which is installed above the paper feeder 18 rotates backward from a closed state indicated by a solid line in FIG. 1, the tray feed 19 is arranged in an inclined state indicated by a two-dotted line in FIG. 1, so that a plurality of printing papers P can be set. The printing papers P set in the tray feed 19 are fed by the paper feeder 18 sheet by sheet to perform printing. The printer unit 13 corresponds to a normal printing (normal printing mode) in which printing is performed in the flexible recording medium such as a printing paper P which is fed from the tray feed 19 using the paper feeder 18 and a label printing (label printing mode) in which printing is performed on a label surface of a disc. The label printing will be described later. Further, the printer 11 may perform copying according as the printer unit 13 prints images read by the scanner unit 15.

The manipulation panel 16 includes a manipulation unit 20 for performing a variety of manipulations with respect to the printer 11 and a display unit 21 in which a variety of menus, images or the like are displayed. A power switch 22, a printing start switch 23, a copy switch 24, a selection switch 25 and the like are installed in the manipulation unit 20. For example, normal printing (normal printing mode) in which printing is performed on the recording medium such as printing paper is performed by setting the printing paper in the tray feed 19 to press the printing start switch 23. Further, the label printing (label printing mode) is performed by manipulating the selection switch 25 to select the label printing mode in mode selection menus on the display unit 21, by selecting a necessary setting item (CD size, image selection or the like) in a setting screen of sub menus, and then by pressing the printing start switch 23. The printer 11 is able to print an image or a document based on print data received from a host apparatus (not shown) and also able to print an image read from a memory card (not shown) inserted into a slot 26 installed in a front surface of the main body 12.

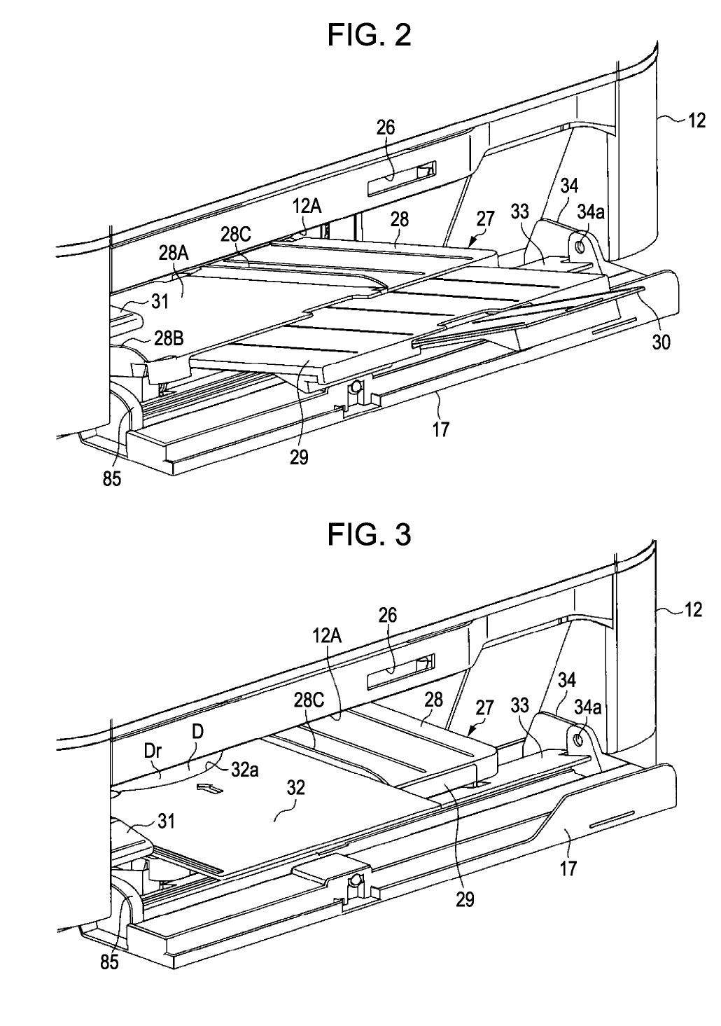

Since the cover 17 installed in the front lower side of the main body 12 covers a paper discharging port (medium discharging port) of the main body 12 in the closed state shown in FIG. 1, a stacker 27 (see FIGS. 2 and 3) is accommodated inside of the cover 17. When performing printing, a user opens the cover 17 shown in FIG. 1 to arrange the stacker 27 with a predetermined posture corresponding to its usage.

FIGS. 2 and 3 illustrate perspective views of the stacker 27 shown in the state that the cover is open. In this embodiment, the stacker 27 has a stack function that stacks the flexible recording medium such as a printing paper discharged in the normal printing (normal printing mode) and a tray feed function for feeding the hard recording medium such as a disc in the label printing (label printing mode) into the printer unit 13. FIG. 2 illustrates a stacker in a posture when used as the stack function of the flexible recording medium; and FIG. 3 illustrates the stacker in a posture when used as the tray feed function of the hard recording medium. The stacker 27 may change its posture between a first position (first posture) shown in FIG. 2 for realizing the stack function and a second position (second posture) shown in FIG. 3 for realizing the tray feed function.

When the cover 17 is open, as shown in FIG. 2, the stacker 27 is normally arranged in the first position. In the first position, the stacker 27 is arranged in an inclined posture that a front end part thereof (right front side in FIG. 2) is located higher than a base end part side thereof (left-inner side in FIG. 2). The stacker 27 has a three staged slide configuration and includes a rectangular plate shaped stacker main body 28, a rectangular plate shaped main support plate 29 which is slightly smaller than the stacker main body 28, which is engaged with a lower surface of the stacker main body 28 to be able to slide, and a minimum rectangular plate shaped sub support plate 30 which is engaged with the main support plate 29 so as to be able to slide. When performing printing by setting the flexible recording medium such as printing paper in the tray feed 19 and feeding the set flexible recording medium to the paper feeder 18 (in the normal printing mode), the stacker 27 is arranged in the first position shown in FIG. 2. In normal printing, the stacker 27 is used in an extended state such that the support plates 29 and 30 are slid out of the stacker main body 28 as shown in FIG. 2. The flexible recording medium such as printing paper P discharged after completion of printing is stacked on the stacker 27 of the first position (inclination posture).

In FIG. 2, in a left side of the stacker 27, a manipulation lever 31 is installed for changing its posture (position). A manipulation section 31a of the manipulation lever 31 is manipulated up and down, and thus, the posture of the stacker 27 may be changed. If the manipulation section 31a is pressed down in the state that the stacker 27 is in the first position, the stacker 27 is changed into the second position shown in FIG. 3. Further, if the manipulation section 31a is pressed up in the state that the stacker 27 is in the second position, the stacker 27 is changed into the second position shown in FIG. 2.

As shown in FIG. 2, in one end part of a width direction of the stacker main body 28 (left end part in FIG. 2), a side wall section 28B is formed to extend in a transport direction. Further, in a position on a guide surface 28A, which is spaced from the side wall section 28B by a predetermined distance in the width direction, a protrusion section 28C (guide rib) is installed to extend in a direction (transport direction) parallel to the side wall section 28B.

In the label printing, the stacker 27 is arranged in the second position (horizontal posture) shown in FIG. 3 in which the guide surface 28A (feed stack surface) becomes horizontal. Further, as shown in FIG. 3, a disc D is set in a circular recess section 32a on a surface of a rectangular plate shaped disc hold tray 32 which is used in the label printing, and then, the disc hold tray 32 is set (stacked) on the guide surface 28A between the side wall section 28B and the protrusion section 28C. The stacker 27 is arranged in the second position (horizontal posture) in the label printing, and thus serves as a feed tray for feeding the disc hold tray 32. In the label printing, as shown in FIG. 3, the stacker 27 is used in a withdrawn state that the support plates 29 and 30 are withdrawn in the stacker main body 28.

If the printing start switch 23 is manipulated in the label printing mode, a transport mechanism of the printer unit 13 is operated so that the disc hold tray 32 set on the stacker 27 is transported to a recording unit. At this time, the disc hold tray 32 is positioned in the width direction by the side wall section 28B and the protrusion section 28C, and is transported on a parallel transporting path with a bottom surface thereof being supported on the guide surface 28A. Further, after completion of feeding, the disc hold tray 32 is transported in a downstream side of the transport direction. In this transport process, printing is performed on a label surface Dr of the disc D and the label printed disc D is again discharged on the stacker 27.

The cover 17 is installed to rotate centering around shaft sections 34a (one shaft section 34a is shown in FIGS. 2 and 3) of support plate sections 34 which extend in an upper direction at opposite sides of the width direction of a front end part (downstream side end part of the transport direction) of a lower housing 33 which forms a bottom plate section of the printer 11. Since the stacker 27 may change its posture in the front end part of the lower housing 33, the front end part of the stacker main body 28 is supported so that it is able to rotate.

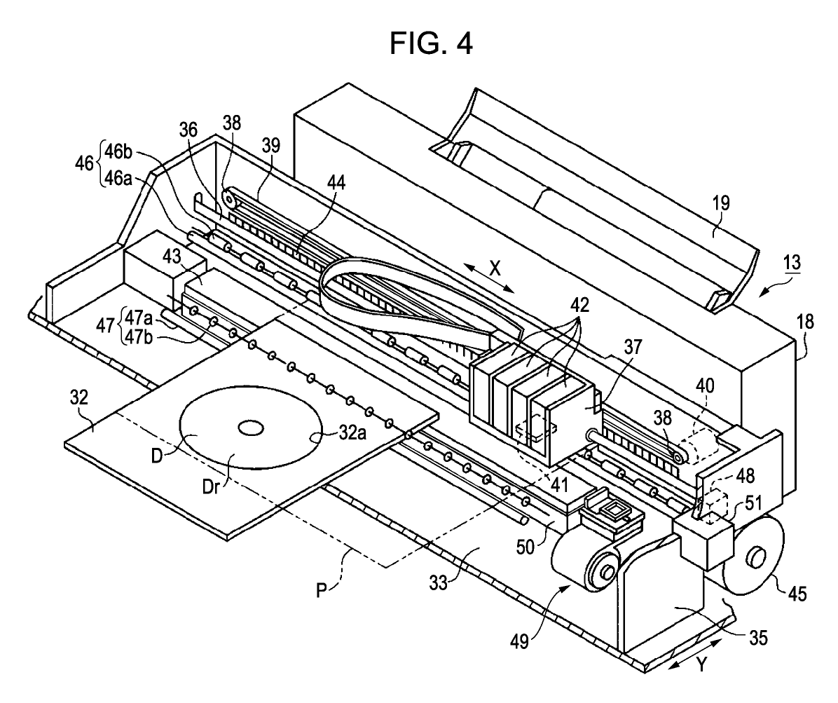

Next, a configuration of the printer unit 13 will be described. FIG. 4 illustrates a perspective view of the printer unit in the state that an external housing is separated. As shown in FIG. 4, the printer unit 13 is provided with an approximately rectangular box shaped main body frame 35 in which an upper side and a front side are open. The main body frame 35 is combined with the lower housing 33 which forms a bottom section of the external housing.

A guide shaft 36 having a predetermined length is installed between a right side wall and a left side wall of the main body frame 35 in FIG. 4, and a carriage 37 is installed to reciprocally move in a main scanning direction X along the guide shaft 36. The carriage 37 is fixed to an endless timing belt 39 which is wound in a pair of pulleys 38 which is installed on an inner surface of a rear plate of the main body frame 35. A carriage motor 40 having a drive shaft which is installed in the right side pulley 38 in FIG. 4 is driven forwardly and in reverse to rotate the timing belt 39 forwardly and reversely, and thus, the carriage 37 reciprocally moves in the main scanning direction X.

An ink jet typed recording head 41 is installed in a lower part of the carriage 37. A plurality of nozzle rows which ejects ink is open on a lower surface of the recording head 41. Further, a plurality of ink cartridges 42 is mounted on an upper part of the carriage 37. The ink cartridge 42 contains four colors ink, for example, black (K), cyan (C), magenta (M) and yellow (Y). The ink colors are not limited to the four colors, and may be three colors or five to eight colors. The recording head 41 ejects ink supplied from each ink cartridge 42 from the nozzles corresponding to the colors.

In a lower position opposite to the recording head 41, a platen 43 which regulates intervals (gap) between the recording head 41 and the recording medium is installed. The platen 43 extends in the width direction (X direction in FIG. 4) in a range including a printing region in which printing is performed by the recording head 41. In the transport direction (Y direction), a region opposite to the nozzles of the recording head 41 becomes the recording position. In the recording position, the flexible recording medium (for example, printing paper P) and the hard recording medium (for example, disc D) are supported on the upper surface of the platen 43. During printing, ink is ejected onto the recording medium which is transported in the recording position. Further, during transporting, the upper surface of the platen 43 becomes a transport surface which supports the recording medium. Accordingly, in the recording unit, feeding, transporting and discharging are performed for the flexible recording medium and the hard recording medium along a horizontal path in which the upper surface of the platen 43 serves as the transport surface.

Further, a linear encoder 44, which outputs a number of pluses which is proportional to the amount of movement of the carriage 37, is provided to extend along the guide shaft 36 in a rear surface side of the carriage 37.

In addition, a transport motor 45 is installed in a right lower part of the main body frame 35 in FIG. 4. A transport roller set 46 and a discharge roller set 47 are respectively arranged on the upstream side and the downstream side of the platen 43 in the transport direction Y. The transport roller set 46 includes a transport drive roller 46a which is driven to rotate by power of the transport motor 45 and a transport driven roller 46b which rotates in contact with the transport drive roller 46a. Moreover, the discharge roller set 47 includes a discharge drive roller 47a which is driven to rotate by power of the transport motor 45 and a discharge driven roller 47b which rotates in contact with the discharge drive roller 47a.

As the transport motor 45 is operated to rotate, the transport drive roller 46a and the discharge drive roller 47a are driven, and the printing paper P or the disc hold tray 32 is transported in the sub scanning direction Y in the state of being interposed (nipped) between the roller sets 46 and 47. The stacker 27 in FIG. 3 is arranged in the second position to form a straight line transporting path (a horizontal path in this embodiment) in cooperation with the upper surface (transport surface) of the platen 43. As described above, as the stacker 27 is arranged in a posture (horizontal posture) in which the guide surface 28A which is the upper surface of the stacker 27 has the same height as the horizontal upper surface of the platen 43 and becomes parallel thereto, a feeding path may be formed for feeding the disc D on the horizontal upper surface of the platen 43.

As shown in FIG. 4, a printing operation which ejects ink onto the printing paper P or the label surface of the disc D from the nozzles of the recording head 41 while reciprocally moving the carriage 37 in the main scanning direction X, and a feeding operation, which transports the printing paper P or the disc D in the sub scanning direction Y by a predetermined transporting amount, are alternately repeated, thereby performing printing of images, texts or the like on the printing paper P or the disc D.

When performing recording by the recording head 41, the platen 43 serves as a support surface which supports the recording medium, and a transport surface which supports the lower surface of the recording medium during transporting. In printing, the printing is performed in part of the recording medium opposite to the nozzles of the recording head 41 located on the upper surface of the platen 43 in the transport direction (Y direction in FIG. 4), and a printing position on the platen 43 corresponds to the recording position.

In the normal printing mode, the paper feeder 18 separates only the uppermost one among the plurality of printing papers P stacked on the tray feed 19 (see FIG. 1) to feed in the downstream side of the sub scanning direction Y. Then, the printing papers discharged after completion of printing are stacked on the stacker 27 which is in the first position (inclined posture) shown in FIG. 2 from the height of the upper surface of the platen 43.

On the other hand, in the label printing mode, the disc hold tray 32 which is set on the upper surface of the stacker 27 arranged in the second position (horizontal posture) shown in FIG. 3 is fed onto the platen 43 by the reverse rotation of both the roller sets 46 and 47 in the state of being guided by the paper discharging roller set 47 and the paper transport roller set 46 being interposed (nipped) therebetween according as the transport motor 45 shown in FIG. 4 is reversely operated. Further, the fed disc hold tray 32 is transported to the downstream side of the transport direction by both the roller sets 46 and 47 which forwardly rotate by the forward rotational driving of the transport motor 45. In the transporting process to the downstream side of the transport direction, printing is performed on the label surface of the disc D which is set in the disc hold tray 32. Further, if the label printing is completed, the disc hold tray 32 is transported to the downstream side of the transport direction by the forward rotation of the transport roller set 46 and the discharge roller set 47, to be discharged on the upper surface of the stacker 27 which is in the posture of the second position from the upper surface of the platen 43. As the upper surface of the stacker 27 in the first position is arranged in the horizontal state having the same height as the upper surface of the platen 43, the disc hold tray 32 may be fed and discharged without applying bending stress to the disc D set in the disc hold tray 32. Further, the posture when the stacker is in the second position is not limited to the horizontal posture, but may be any posture parallel to the transport surface. For example, in the case where the transport surface (medium support surface) of the platen is inclined with respect to the horizontal state, a straight line path with respect to the inclined transport surface may be formed. Further, in the case of a cylindrical platen, the upper surface of the stacker may be located on an extension of a tangential line in the recording position in an outer circumferential surface of the platen.

In order to adjust an interval (platen gap) between the recording head 41 and the platen 43, a platen gap auto adjustment apparatus (hereinafter, referred to as “APG apparatus 48”) which moves the carriage 37 upward and downward is installed in the printer unit 13. The APG apparatus 48 is driven so that an appropriate platen gap can be secured according to the type of the recording medium obtained from printing condition information included in the printing data received from the host apparatus or setting information which is set by the manipulation panel 16, and the carriage 37 is adjusted in its position to such a height that the appropriate platen gap can be secured. In addition, in the label printing mode, the APG apparatus 48 is driven so that the platen gap which is widened according to the thickness of the disc hold tray 32 can be secured, and the carriage 37 is arranged, for example, at the highest point in a height direction of a movement range. Accordingly, in the label printing, an appropriate gap is secured between the recording head 41 and the label surface Dr of the disc D which is set in the disc hold tray 32.

In FIG. 4, an end part position (right end part position in FIG. 4) on the movement path of the carriage 37 is a home position. A maintenance apparatus 49 which performs maintenance such as nozzle cleaning with respect to the recording head 41 is installed under the carriage 37 arranged in the home position. Waste ink which is suctioned from the nozzles of the recording head 41 and discharged by the maintenance apparatus 49 is discharged to a waste ink tank 50 which is arranged under the platen 43.

In this embodiment, the transport motor 45 is a common power source of the paper feeder 18, the APG apparatus 48, and the maintenance apparatus 49 as well as the transport drive roller 46a and the discharge drive roller 47a. If the carriage 37 is arranged in a switching position adjacent to the home position, connection of a power transmission switching apparatus 51 is cut off. Then, the transport motor 45 is operated in the cut off state to select a connection target (switching target). Thereafter, the carriage 37 is withdrawn from the switching position, and thus, a power transmission path of the transport motor 45 is connected to the selected connection target.

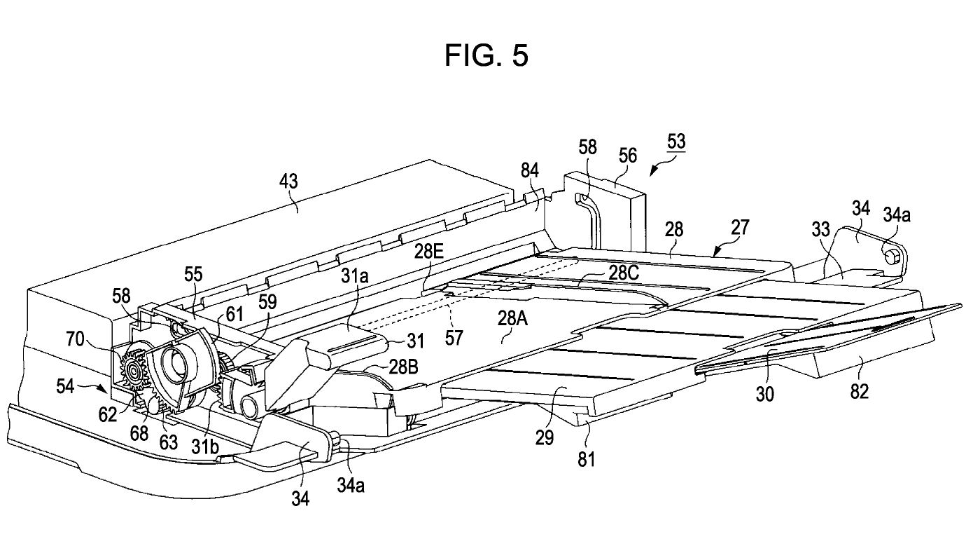

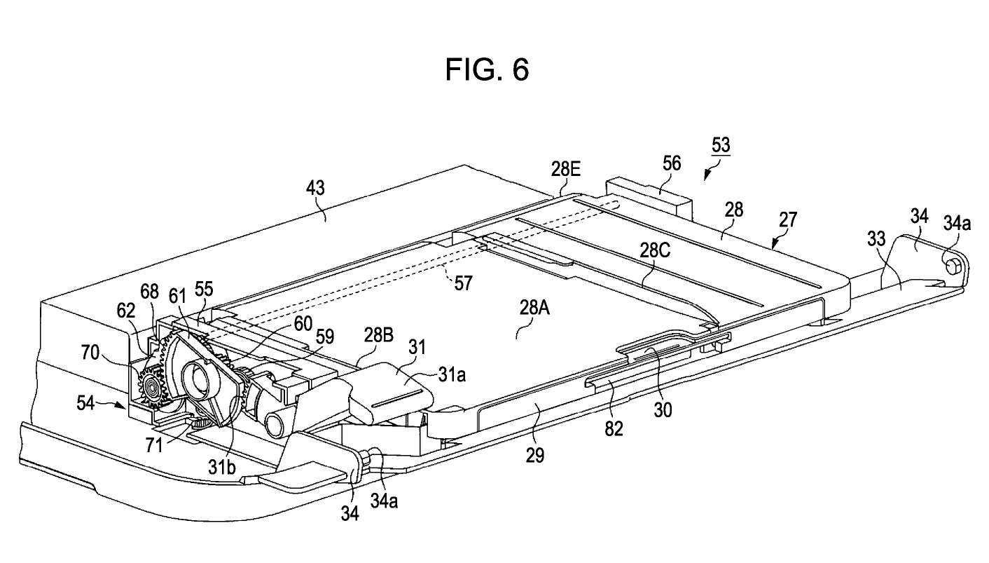

Next, a specific configuration of a stacker unit having the stacker 27 will be described. FIGS. 5 and 6 illustrate perspective views of the stacker unit which includes the stacker and a drive system thereof. Here, FIG. 5 illustrates a perspective view of the stacker unit when the stacker is arranged in the second position; and FIG. 6 illustrates a perspective view of the stacker unit when the stacker is arranged in the first position.

As shown in FIG. 5, a stacker unit 53 is assembled on the bottom plate of the main body frame 35 in a position approximately adjacent to a downstream side of the transport direction with respect to the platen 43. The stacker unit 53 includes the rectangular plate shaped stacker 27 capable of changing its position into the first position and second position, the manipulation lever 31 for performing the manipulation for changing the posture of the stacker 27, and a power transmission gear mechanism 54 which serves as the power transmission mechanism for transmitting the manipulation force of the manipulation lever 31 to the stacker 27 so as to change the posture of the stacker 27.

The opposite sides of the width direction of the front end part (end part of the downstream side in the transport direction) of the stacker 27 are supported so as to be able to rotate with respect to the lower housing 33 which is installed on the bottom plate of the main body frame 35. A pair of right and left support members 55 and 56 is provided at an interval slightly wider than the maximum printing paper width in the width direction (X direction), in positions corresponding to the opposite sides in the width direction of the base end part (end part of the upstream side of the transport direction) of the stacker 27. In the base end part of the stacker 27, opposite end parts of a support shaft 57, which extends in the width direction of the base part and protrudes outward beyond the width of the base part, are inserted in a horizontal U-shaped guide hole 58 as a guide means formed in the pair of right and left support members 55 and 56. Thus, the base end part of the stacker 27 is supported to be displaced upward and downward.

The power transmission gear mechanism 54 includes a tooth section 31b formed in an end edge of the manipulation lever 31, gears 59 and 60, a complex gear 61, a rotation cam 62, a pinion 63, and the like. The pinion 63 is fixed in the opposite end parts of the support shaft 57. Accordingly, as the support shaft 57 which is coupled with the base end part of the stacker 27 is displaced upward and downward along the horizontal U-shaped guide hole 58, the stacker 27 may rotate with the front end part thereof which is coupled and supported with respect to the lower housing 33 being a supporting point, and may change its posture between the first position shown in FIG. 5 and the second position shown in FIG. 6.

As shown in FIG. 5, in a first manipulation position which the manipulation section 31a of the manipulation lever 31 is located in the upper position, the pinion 63 is located in a downward position. Thus, the stacker 27 is arranged in the first position (first posture) for stacking the flexible recording medium such as printing paper P in the inclined state that the front end part (first end part) which is distant from the recording position on the platen 43 in the transport direction is located above the base end part (second end part) which is near thereto. On the other hand, if the manipulation section 31a is pressed down from the first manipulation position to the second manipulation position, as shown in FIG. 6, due to power based on the manipulation force transmitted through the power transmission gear mechanism 54, the rotation cam 62 rotates and the pinion 63 moves up, and thus the stacker 27 is arranged in the second position (second posture) which is the horizontal posture in which the base end part thereof is moved up. In the second position, the straight line transporting path for transporting the hard recording medium (in this embodiment, to disc hold tray 32 in which the disc D is set) such as a disc D toward the recording position is formed by the stacker 27 and the platen 43. In this way, the stacker 27 according to the present embodiment feeds the disc D as the recording medium in the state of being set in the disc hold tray 32. A configuration in which only the disc D is fed may be employed.

In the label printing, the stacker 27 is arranged in the second position shown in FIG. 6, the disc hold tray 32 shown in FIG. 3 is set between the side wall section 28B and the protrusion section 28C. Next, by pressing the printing start switch 23 in the label printing mode, the disc hold tray 32 is positioned in the width direction by a distance between the side wall section 28B and the protrusion section 28C and is fed on the platen 43 which becomes the printing position. After the disc hold tray 32 is fed to a disc feeding position on the upstream side from the printing position opposite to the recording head 41 in the transport direction, the disc hold tray 32 is fed to the downstream side in the transport direction to be placed in the printing start position. Thereafter, printing is performed on the label surface Dr of the disc D while the disc hold tray 32 is fed to the downstream side in the transport direction.

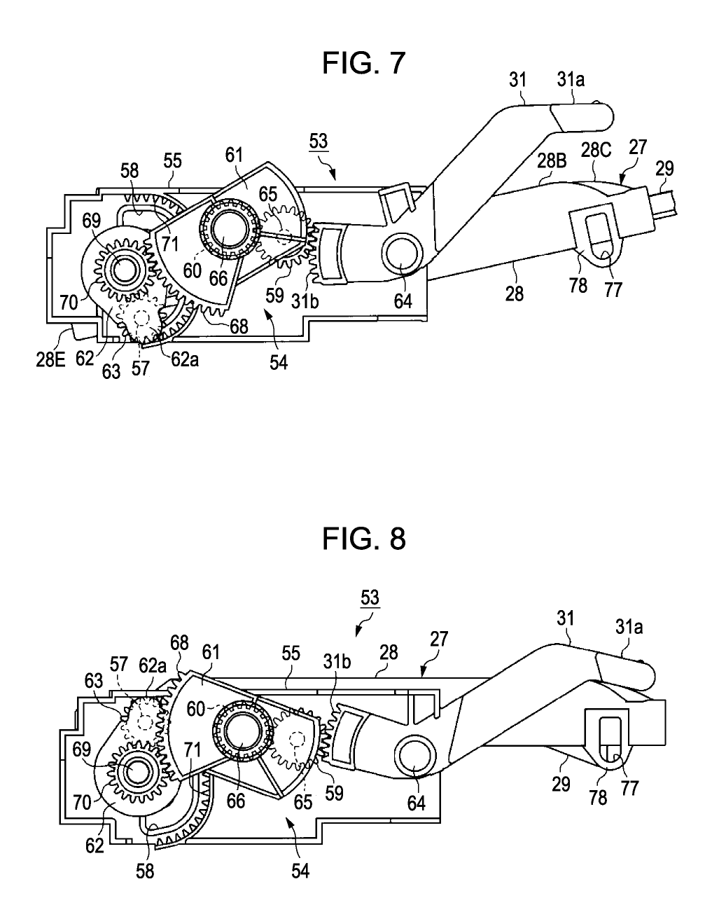

Next, a configuration of the power transmission gear mechanism 54 will be described in detail. FIG. 7 is a side view of the power transmission gear mechanism. As shown in FIG. 7, the power transmission gear mechanism 54 is installed in the first support member 55 (main support member) among the pair of right and left support members 55 and 56.

As shown in FIG. 7, the manipulation lever 31 is supported so that it is able to rotate centering around a shaft section 64 which protrudes from an outer side surface of the first support member 55. The tooth section 31b is formed in the end edge opposite to the manipulate section 31a with the rotation center (shaft section 64) of the manipulation lever 31 being interposed therebetween. The tooth section 31b is engaged with the gear 59 which is supported so that it is able to rotate centering around a shaft section 65 which protrudes from the outer surface of the first support member 55. The complex gear 61 is supported so that it is able to rotate centering around a shaft section 66 which protrudes from the outer surface of the first support member 55, and has the gear 60 which integrally rotates centering around the shaft section 66 on a surface thereof opposite to the first support member 55. The gear 60 is engaged with the gear 59. In the complex gear 61, a side opposite to the manipulation lever 31 extends in a fan-like form, and a tooth section 68 is formed in a peripheral edge part of the fan-like side.

In the first support member 55, the horizontal U-shaped guide hole 58 is open in a left position thereof in the length direction thereof in FIGS. 7 and 8. The horizontal U-shaped guide hole 58 in this embodiment is arranged in a direction to be convex toward the manipulation lever 31. A shaft section 69 protrudes from the outer side surface of the first support member 55, in a position of half of the height of the guide hole 58 on the left side of the guide hole 58. The rotation cam 62 and the gear 70 are supported to integrally rotate with respect to the shaft section 69. Further, the fan-like tooth section 68 of the complex gear 61 is engaged with the gear 70. The rotation cam 62 has an extension section 62a which extends in a rotational radius direction thereof, and the pinion 63 is installed to the extension section 62a so that it is able to rotate.

Further, on the outer surface of the first support member 55, a rack 71 is installed along the horizontal U-shaped guide hole 58. The rack 71 has a plurality of teeth which is arranged in a horizontal U-shape along the outer circumference of the guide hole 58. The pinion 63 which is installed to the extension section 62a so that it is able to rotate, is fixed to one end part of the support shaft 57 inserted in the guide hole 58 and also is engaged with the rack 71.

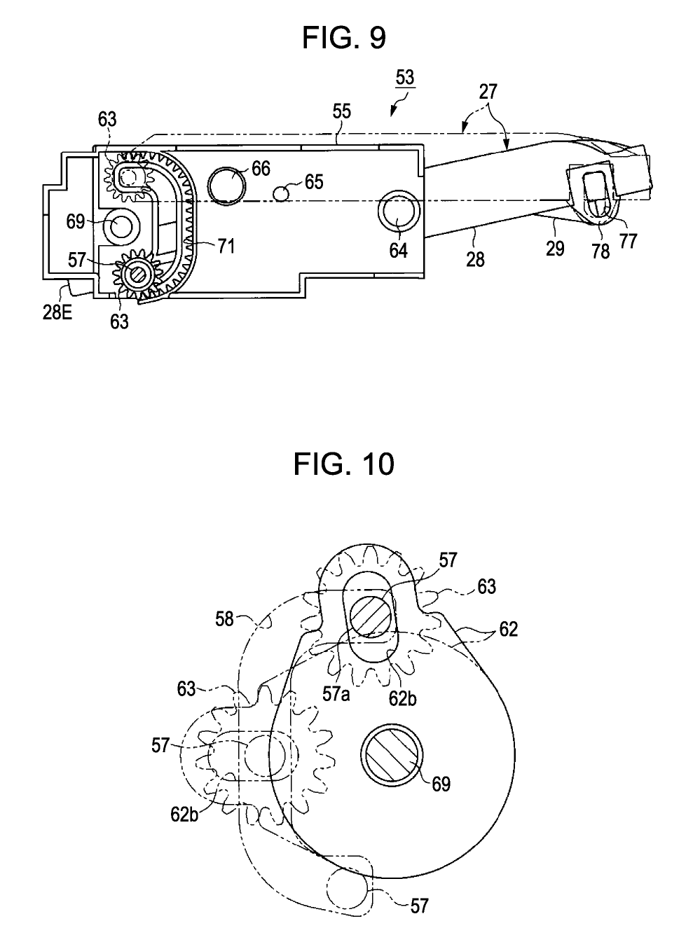

FIG. 9 is a side view illustrating the pinion 63, with the main components of the power transmission gear mechanism 54 such as a rotation cam 62 or gears being omitted. As shown in FIG. 9, the support shaft 57 which is inserted in the horizontal U-shaped guide hole 58 supports the base end part of the stacker 27. As the rotation cam 62 rotates by the up and down manipulation of the manipulation lever 31, the support shaft 57 moves upward and downward along the guide hole 58. That is, the support shaft 57 is installed so as to be able to move upward and downward while supporting the base end part (second end part) of the stacker 27.

Accordingly, in the state that the manipulation lever 31 is in the first manipulation position shown in FIG. 7, the components of the power transmission gear mechanism 54 are in the rotation posture shown in FIG. 7. At this time, the rotation cam 62 is in the rotation posture with the extension section 62a being inclined down, and the support shaft 57 is located in a lower end part of the guide hole 58 as indicated by solid lines in FIGS. 7 and 9. Thus, when the manipulation lever 31 is in the first manipulation position shown in FIG. 7, the stacker 27 is arranged in the first position in which the front end part of the downstream side (right side in FIGS. 7 and 9) in the transport direction as indicated by the solid lines in FIGS. 7 and 9 is in the inclined posture which is located higher than the base end part.

If the manipulation lever 31 is pressed down from the state shown in FIG. 7, the complex gear 61 rotates in a clockwise direction in FIG. 7 through the tooth section 31b, the gears 59 and 60, and the rotation cam 62 rotates in a counterclockwise direction in FIG. 7 together with the gear 70 which is engaged with the tooth section 68 of the complex gear 61. As a result, in the state that the manipulation lever 31 is in the second manipulation position shown in FIG. 8, the support shaft 57 is located on an upper end part in the horizontal U-shaped guide hole 58 as indicated by two-dotted lines in FIGS. 8 and 9. At this time, the stacker 27 is arranged in the second position in which the stacker 27 is in the horizontal posture as indicated by two-dotted lines in FIGS. 8 and 9.

Here, as shown in FIGS. 7 and 8, the gear 59 which is engaged with the tooth section 31b formed in the end edge part of the manipulation lever 31 and the gear 60 have approximately the same radius (approximately the same tooth number), and the tooth section 68 of the complex gear 61 has a rotation radius larger than that of the gear 60. Further, the rotation shaft center position (or support shaft 57) of the pinion 63 which rotates centering around the shaft section 69 has a rotation radius larger than that of the gear 70 engaged with the tooth section 68. Accordingly, when manipulating the manipulation lever 31, power transmitted to the tooth section 31b of the end edge part thereof is speed-increased through the gears 59 and 60, the complex gear 61, the rotation cam 62 and the like, and then, is transmitted to the support shaft 57. In this way, since the power transmission gear mechanism 54 speed-increases the power which is transmitted to the tooth section 31b of the end edge part of the manipulation lever 31 to be transmitted to the support shaft 57, by forming a hole shape of the guide hole 58 in the horizontal U-shape, the amount of the manipulation of the manipulation lever 31 is small even though the movement path of the support shaft 57 is relatively long.

FIG. 10 is a side view illustrating an installation configuration of the pinion with respect to the rotation cam. As shown in FIG. 10, on a rear surface of the rotation cam 62 which is opposite to the guide hole 58, a guide groove 62b which extends along a rotational radius direction of the rotation cam 62 is formed in the extension section 62a. A shaft end part 57a of the support shaft 57 inserted in the guide hole 58, which passes through the pinion 63, is inserted in the guide groove 62b. Thus, the pinion 63 and the support shaft 57 relatively move in the rotational radius direction thereof with respect to the rotation cam 62 along the guide groove 62b. Accordingly, even though the guide hole 58 is formed in the horizontal U-shaped hole other than a circular arc shape, the support shaft 57 is able to move along the guide hole 58. Instead of the shaft end part 57a of the support shaft 57, a shaft section integrally formed in the pinion 63 may be inserted in the guide groove 62b.

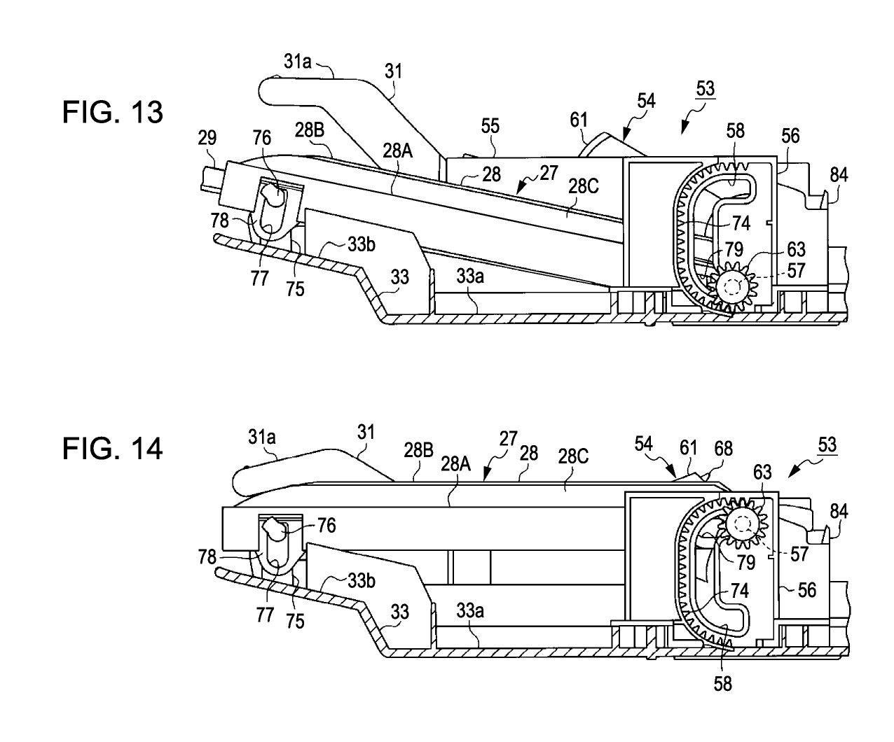

FIGS. 13 and 14 illustrate a side view of the stacker when seen from the second support member. The second support member 56 is a member which makes a pair with respect to a region of the first support member 55 in which the horizontal U-shaped guide hole 58 is formed. The second support member 56 is a plate shaped member which is short in length in the transport direction compared with the first support member 55 and has the same height as the first support member 55, and is installed in parallel with the first support member 55 in a position which is space from the first support member 55 at an interval slightly wider than the width of the stacker 27. The horizontal U-shaped guide hole 58 and a rack 74 having a plurality of teeth which is arranged in the horizontal U-shape along the guide hole 58 are formed in the second support member 56. The rack 74 has the same shape as in the rack 71 in the first support member 55, and is arranged to be convex toward the manipulation lever 31. The other end part of the support shaft 57 in the second support member 56 is also inserted in the guide hole 58, and the pinion 63 which is fixed to an outside of the other inserted end part of the support shaft 57 is engaged with the rack 74.

In this embodiment, one side (first support member 55) of the axial opposite sides of the support shaft 57 to which the pair of pinions 63 is fixed becomes a drive side to which power based on the manipulation of the manipulation lever 31 is input through the power transmission gear mechanism 54. Due to the rotation of the rotation cam 62, the drive side of the axial opposite sides of the support shaft 57 moves along the guide hole 58. Further, the other side (second support member 56) of the axial opposite sides of the support shaft 57 is a driven side which moves the other side of the support shaft 57 upward and downward as the pinion 63 of the other side (driven side), which is installed on the axial opposite side of the support shaft 57, is driven to rotate by the rotation of the pinion 63 of the drive side (one end part). Accordingly, when manipulating the manipulation lever 31, as the rotation cam 62 rotates, power for moving the support shaft 57 upward and downward is input to the one end part of the support shaft 57, and when the one end part of the support shaft 57 moves upward and downward, the pinion 63 of the drive side rotates to be engaged with the rack 71. This rotation is transmitted to the other end part thereof through the rotation of the support shaft 57, and thus, the pinion 63 of the other end part (driven side) rotates. The pinion 63 in the driven side rotates while being engaged with the rack 74, and thus, the power for moving the support shaft 57 upward and downward is also transmitted to the other end part of the support shaft 57. In this way, the pinion 63 in the drive side and the pinion 63 in the driven side rotate together, and the support shaft 57 is supported at the axial opposite sides thereof to be able to move upward and downward.

As shown in FIGS. 13 and 14, the lower housing 33 includes a bottom plate section 33a which horizontally extends in a position corresponding to a region of the base end part of the stacker 27 in the transport direction (right and left direction in FIGS. 13 and 14), and an extension plate section 33b which extends in an upward inclined direction which increase in height toward a downstream side of the transport direction (left side in the FIGS. 13 and 14) in a position corresponding to a region of the front end part of the stacker main body 28. In the proximity of the front end part of the extension plate section 33b, a support section 75 extends upward from an upper surface thereof. A coupling protrusion 76 which is a coupling support section protrudes from a side surface of an upper end part of the support section 75. On the other hand, in a position of a side surface of the front end part of the stacker main body 28 corresponding to the coupling protrusion 76, an extension section 78 having a support hole 77 formed of an elongated hole which extends in a direction perpendicular to a direction (lengthwise direction) which extends toward the base end part thereof extends in a downward direction which is perpendicular to the stacker main body 28. The extension section 78 and the support section 75 are installed as a pair on the opposite sides of the width direction of the front end part of the stacker main body 28.

As each coupling protrusion 76 is inserted to each support hole 77, the stacker main body 28 is supported so that it is able to rotate centering around the coupling position (front end part) of the support hole 77 and the coupling protrusion 76 on the right and left opposite sides of the front end part thereof. Accordingly, the stacker 27 moves the base end part thereof upward and downward to rotate centering around the front end part (the coupling position of the coupling protrusion 76 and the support hole 77) of the stacker main body 28. In this embodiment, the support section 75, which supports the front end part (first end part) of the stacker 27 so that it is able to rotate, forms a first support unit.

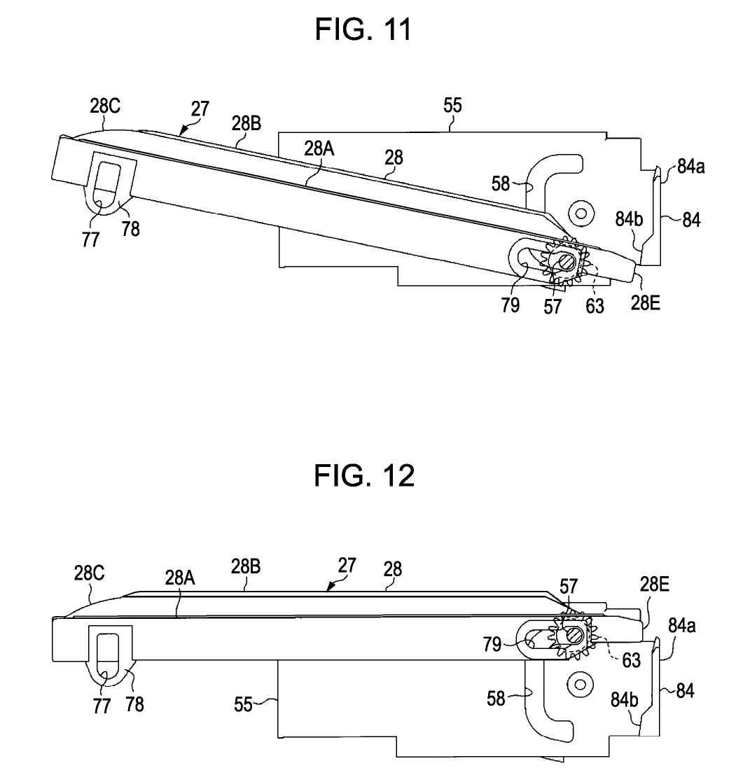

FIGS. 11 and 12 illustrate side views of the stacker when seen from an opposite side to the power transmission mechanism. The figures correspond to side views of the stacker which are cut out between the stacker and the second support member. As shown in FIGS. 11 and 12, an elongated hole 79 which is the cut-out section extending toward the front end part thereof is formed in the base end part of the stacker 27. The elongated hole 79 is formed on the opposite sides of the width direction of the stacker main body 28, and the support shaft 57 is inserted in the right and left elongated holes 79. Accordingly, the support shaft 57 supports the base end part of the stacker 27 to be able to move upward and downward through the right and left elongated holes 79. In the process that the stacker 27 rotates to change its posture between the first position shown in FIG. 11 and the second position shown in FIG. 12, the support shaft 57 inserted to the elongated hole 79 may be relatively displaced in the rotational radius direction thereof with respect to the stacker 27. Thus, the support shaft 57 may move in the movement path along the guide hole 58. In this embodiment, a second support unit includes a mechanism which includes the support shaft 57 which moves upward and downward while supporting the base end part of the stacker 27, the horizontal U-shaped guide hole 58 for displacing the support shaft 57 upward and downward, the one pair of pinions 63, the racks 71 and 74, and the like.

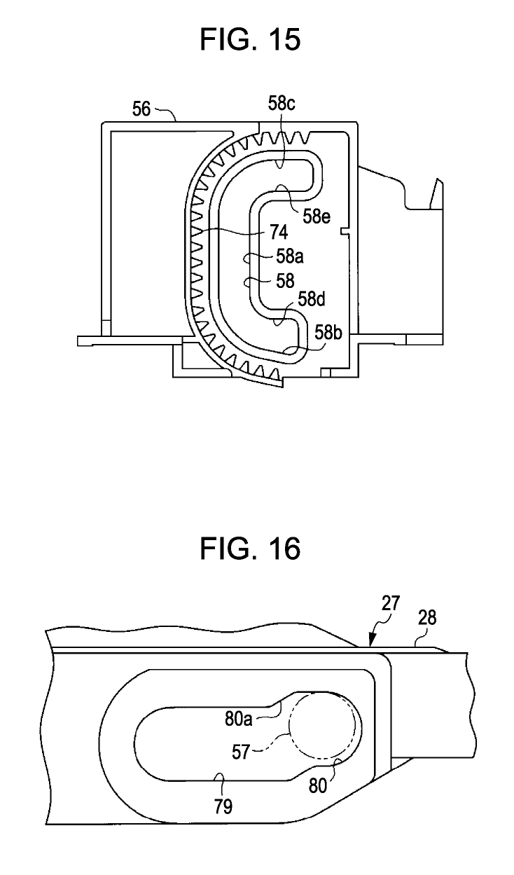

Here, FIG. 15 is a side view of the horizontal U-shaped guide hole 58. The horizontal U-shaped guide hole 58 is arranged in both the first support member 55 and the second support member 56, which have the same configuration. Hereinafter, the horizontal U-shaped guide hole 58 of the second support member 56 is described by way of example. As shown in FIG. 15, the horizontal U-shaped guide hole 58 includes a first hole section 58a (vertical hole section) which vertically extends in a straight line shape, a second hole section 58b (horizontal hole section) which approximately horizontally extends from the first hole section 58a in a lower end part of the first hole section 58a, and a third hole section 58c (horizontal hole section) which approximately horizontally extends from the first hole section 58a in an upper end part of the first hole section 58a. An upper wall surface 58d which regulates an upward movement of the support shaft 57 is provided in the second hole section 58b, and a lower wall surface 58e which regulates a downward movement of the support shaft 57 is provided in the third hole section 58c. The first hole section 58a is not necessarily limited to a straight line shape which extends vertically, and may have any shape which can guide the support shaft 57 to be displaced upward and downward. For example, the first hole section 58a may be an inclined shape or a circular arc shape.

As shown in FIG. 11, in the state that the stacker 27 is arranged in the first position, the support shaft 57 is located in the second hole section 58b of the guide hole 58. At this time, the stacker 27 which is in the inclined posture is used in the extended state so that the support plates 29 and 30 as shown in FIGS. 2 and 5 can slide on the downstream side in the transport direction, and the flexible recording medium such as a discharged printing paper P is stacked on the stacker 27. In this state, the weight of the flexible recording medium is applied to the support plates 29 and 30 which further extend toward the front end part from the supporting point (coupling supporting point between the support hole 77 and the coupling protrusion 76) of the front end part of the stacker main body 28. Due to the weight of the flexible recording medium applied to the support plates 29 and 30, force is applied to the stacker 27 for rotating the stacker 27 in the counterclockwise direction in FIGS. 11 and 13 with the front end part of the stacker main body 28 being the supporting point. The force for rotating the stacker 27 in the counterclockwise direction is applied in the state that the support shaft 57 located in the second hole section 58b is in contact with the upper wall surface 58d (regulating surface). That is, in the state that the stacker 27 is in the first position, the upper wall surface 58d serves as a regulating surface which regulates the upward movement (a direction in which the stacker 27 is changed to the second position) of the support shaft 57. Accordingly, the stacker 27 which is in the first position is prevented from deviating from the first position due to an upward displacement of the base end part thereof due to the weight of the stacked flexible recording medium.

Further, as shown in FIG. 12, in the state that the stacker 27 is arranged in the second position, the support shaft 57 is located in the third hole section 58c of the guide hole 58. At this time, the stacker 27 is arranged in the horizontal posture, and force for rotating the stacker 27 in the clockwise direction in FIGS. 12 and 14 with the front end part thereof being the supporting point is applied to the stacker 27 due to the weight of the stacker 27 (or the weight of the disc hold tray 32 which is stacked on the guide surface 28A). The force for rotating the stacker 27 in the clockwise direction is applied in the state that the support shaft 57 which is located in the third hole section 58c is in contact with the lower wall surface 58e (regulating surface). That is, in the state that the stacker 27 is in the second position, the lower wall surface 58e serves as a regulating surface which regulates the downward movement (direction in which the stacker 27 is changed to the first position) of the support shaft 57. Accordingly, the stacker 27 which is in the second position is prevented from deviating from the second position due to a downward displacement of the base end part thereof due to the weight thereof or the like.

FIG. 16 is a side view illustrating the elongated hole of the base end part of the stacker 27. As shown in FIG. 16, the elongated hole 79 extends toward the front end part of the stacker 27 as described above. A locking recess 80 having a region which is recessed upward (on an upper surface side) at a side of the base end part compared with a side of the front end part is formed in an inner circumferential edge of the elongated hole 79 on the side of the base end part. The locking recess 80 includes an inclined surface 80a which is inclined upward toward the side of the base end part, in the recessed position. In the horizontal posture state that the stacker 27 is in the second position, as described above, the force for rotating the stacker 27 in the clockwise direction in FIGS. 12 and 14 with the base end part thereof being the supporting point is generated due to the weight of the stacker 27 or the like, and the support shaft 57 is pressed against the upper wall surface of the elongated hole 79 to be in contact with the lower wall surface 58e of the third hole section 58c. At this time, as shown in FIG. 16, in the state that the support shaft 57 is in the state of being pressed toward the upper wall surface in the locking recess 80 of the elongated hole 79 due to the weight of the stacker 27, and is locked in the locking recess 80, to thereby be prevented from moving inside of the elongated hole 79 toward the front end part (left side in FIG. 16) of the stacker 27 by the existence of the inclined surface 80a. Accordingly, the support shaft 57 which is arranged in the third hole section 58c is positioned by being locked with the locking recess 80 in the elongated hole 79, and thus, the movement toward the first hole section 58a is regulated. Thus, the stacker 27 arranged in the second position is prevented from moving toward the first position due to the weight thereof or the like. Accordingly, the stacker 27 which is arranged in the second position is maintained in the horizontal posture.

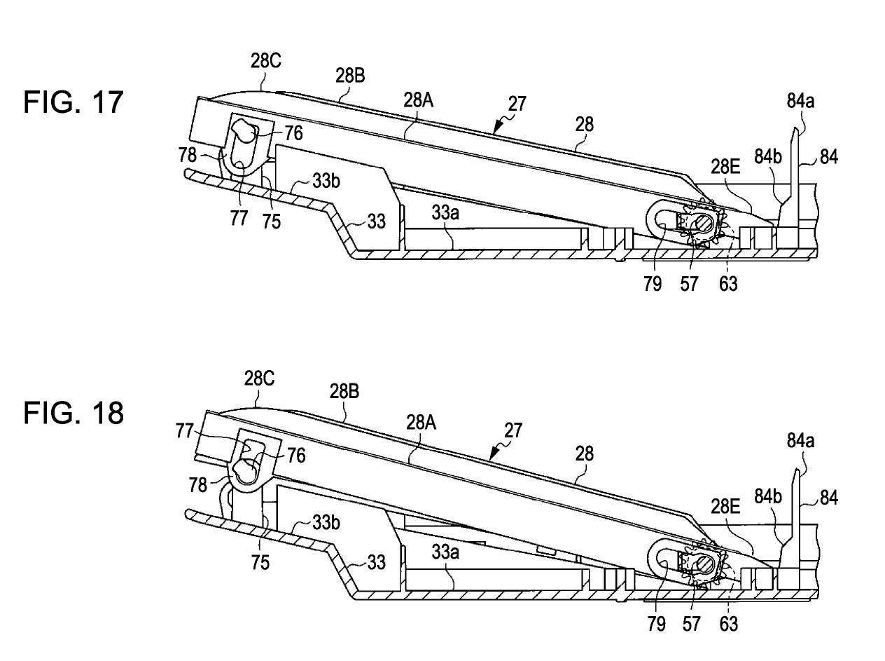

FIGS. 17 and 18 illustrate left side views of the stacker 27 in which the second support member 56 is omitted. As shown in FIG. 17, in the normal printing mode that the stacker 27 is arranged in the first position, in order to slide the stacker 27 in an extension manner, fingers are inserted in a gap between the front end part of the stacker 27 and the lower housing 33 to pull out the support plates 29 and 30. At this time, as the coupling protrusion 76 moves inside of the support hole 77 (elongated hole), the front end part of the stacker 27 (stacker main body 28) is displaced to move toward and away from the lower housing 33. Accordingly, in the state that the stacker 27 is in the first position shown in FIG. 17, if the front end part of the stacker 27 is raised, as the coupling protrusion 76 as shown in FIG. 18 moves downward inside of the support hole 77, the front end part of the stacker 27 is spaced from the lower housing 33, and a gap for insertion of fingers of a user is secured between the front end part of the stacker 27 and the lower housing 33.

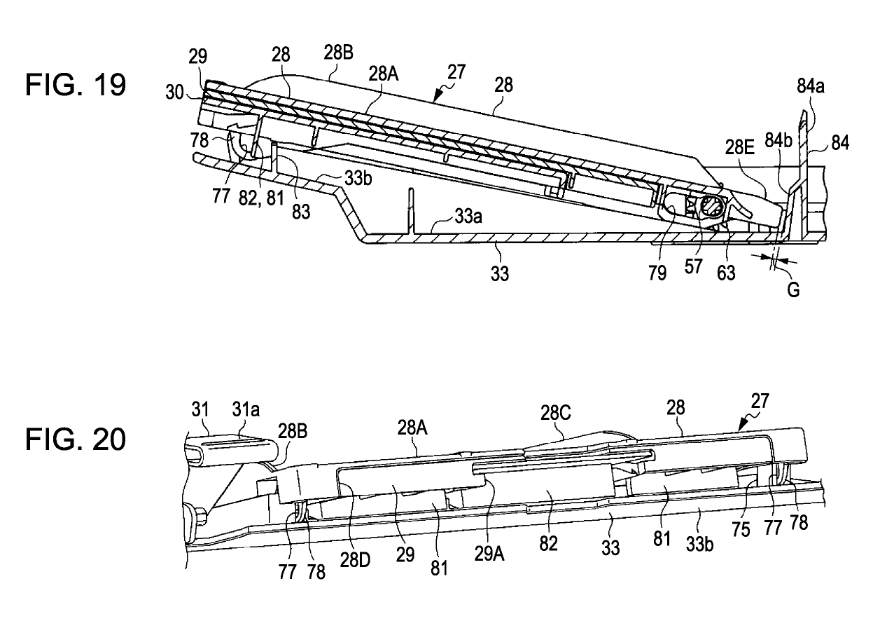

FIG. 19 illustrates a side sectional view of the stacker 27, and FIG. 20 illustrates a perspective view of the front end part of the stacker 27. As shown in FIG. 20, a recess section 28D is open in which the main support plate 29 is accommodated on a front end surface of the stacker main body 28, and a recess section 29A is open in which the sub support plate 30 is accommodated in a front end surface of the main support plate 29. On a lower surface of the front end part of the main support plate 29, in a position which is slightly withdrawn from a front end surface thereof toward a base end part thereof (inward) in the transport direction, a pair of extension wall sections 81 vertically extends downward in opposite side positions thereof with the recess section 29A being interposed therebetween in the width direction. The pair of extension wall sections 81 has a width for shielding a gap of a region in which the recess section 29A is removed in the width direction of the stacker 27. Further, on a lower surface of the front end part of the sub support plate 30, an extension wall section 82 vertically extends downward in a position which is slightly withdrawn from a front end surface thereof toward a base end part thereof (inward) in the transport direction. The extension wall section 82 has a width for shielding a gap of a region corresponding to the recess section 29A in the width direction. Due to the pair of right and left extension wall sections 81 and the single extension wall section 82 disposed therebetween, a gap between the stacker 27 and the lower housing 33 becomes significantly narrow in this region. In addition, as shown in FIG. 20, in the withdrawn state of the stacker 27 that the main support plate 29 and the sub support plate 30 are arranged under the stacker main body 28, the extension wall section 81 of the main support plate 29 and the extension wall section 82 of the sub support plate 30 are arranged in approximately the same positions in the transport direction.

Further, as shown in FIG. 19, on an upper surface of the extension plate section 33b, an extension wall section 83 extends toward the stacker 27 in a position which is slightly withdrawn from the arrangement positions of the respective extension wall sections 81 and 82 toward the base end side of the stacker 27, in the withdrawn state of the stacker 27. The extension wall section 83 has a width which corresponds to all the area of the stacker 27 in the width direction. In the extension wall section 83 of the extension plate section 33b and the extension wall sections 81 and 82 of the stacker 27, front end parts thereof partly overlap with each other in the extension direction (a direction that the lower housing 33 and the stacker 27 move toward and away from each other). Accordingly, even though the front end part of the stacker 27 is displaced upward with respect to the lower housing 33, the overlapping of the front end parts of the extension wall sections 81 and 82 and the extension wall section 83 is secured, or a gap between the extension wall sections 81 and 82 and the extension wall section 83 will be very small even if the overlapping does not occur. The one pair of wall sections in this embodiment refers to a pair of the extension wall sections 81 and 82 of the stacker 27 and the extension wall section 83 of the extension plate section 33b.

Accordingly, even though the gap between the front end part of the stacker 27 and the lower housing 33 is widened as a user inserts his or her fingers in the gap between the front end part of the stacker 27 and the lower housing 33 to raise the front end part of the stacker 27 in order to slide the stacker 27 in the extension manner, the upward and downward gap between the extension wall sections 81 and 82 and the extension wall section 83 becomes significantly narrow. Thus, due to the existence of the extension wall sections 81 and 82 and the extension wall section 83, alien substances or the like are effectively prevented from entering further inside thereof.

Further, as shown in FIGS. 17 to 19, in a position of the upstream side (right side in FIGS. 17 to 19) from the stacker 27 in the transport direction, an extension plate 84 which vertically extends upward from an upper surface of the lower housing 33 is installed. As shown in FIG. 5, the extension plate 84 has a width corresponding to the interval between the first support member 55 and the second support member 56. An upper end part (highest front end part) of the extension plate 84 is positioned at a height slightly lower than the upper surface (transport surface) of the platen 43 and the upper surface (guide surface 28A) (see FIG. 6) of the stacker 27 which is located in the second position.

The extension plate 84 includes a plate section 84a which directly extends in a vertical direction in an upper region thereof (an upper half region in a height direction) and has an approximately constant plate thickness, and an expansion section 84b which expands toward the downstream side in the transport direction in a lower region (base section) of the plate section 84a and has a thickness larger than that of the plate section 84a. Accordingly, as shown in FIG. 19, in the state that the stacker 27 is arranged in the first position, a gap G between a base end 28E of the stacker 27 and the extension plate 84 is maintained to be a value smaller than a predetermined value. Further, as shown in FIG. 6, in the state that the stacker 27 is arranged in the second position, the gap between the base end 28E of the stacker 27 and the platen 43 is maintained to be a value smaller than a predetermined value. Thus, even though the stacker 27 is in either position, for example, alien substances such as a clip can be prevented from entering into the gap of the base end 28E of the stacker 27.

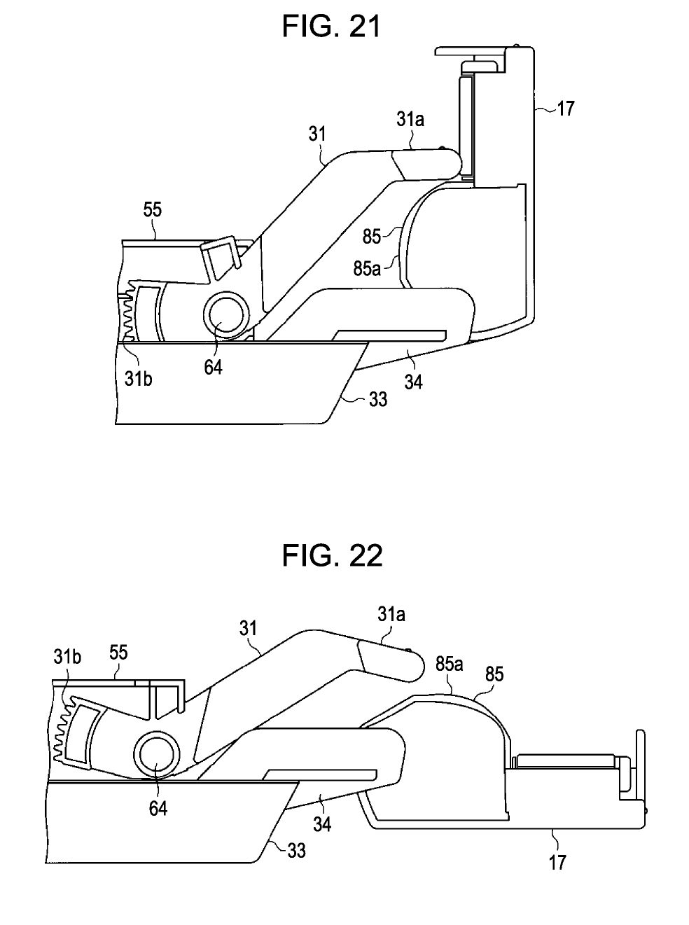

Further, the stacker unit 53 is arranged in the first position by opening and closing of the cover 17. FIGS. 21 and 22 are side views illustrating the manipulation lever and the cover. Here, FIG. 21 illustrates the state that the cover 17 is closed, and FIG. 22 illustrates the state the cover 17 is open and the manipulation lever 31 is in the second manipulation position. In FIGS. 21 and 22, the stacker 27 is omitted.

As shown in FIG. 21, in an inside region of the cover 17 opposite to the manipulation lever 31 is formed an expansion section 85 having a curved surface which expands inward. An inner circumferential surface which is the curved surface of the expansion section 85 serves as a guide surface 85a. In the closed state of the cover 17 shown in FIG. 21, the stacker 27 is arranged in the first position. At this time, the guide surface 85a is not coupled with the manipulation lever 31. Further, in the process of opening the cover 17, the guide surface 85a is not coupled with the manipulation lever 31. On the other hand, FIG. 22 illustrates the state that after opening the cover 17, a user presses down on the manipulation section 31a of the manipulation lever 31 in order to perform the label printing, to thereby switch the stacker 27 from the first position into the second position. After completion of the label printing, if the cover 17 is closed in the state that the manipulation lever 31 is in the second manipulation position, the guide surface 85a is in contact with the manipulation lever 31 to push up the manipulation lever 31. Accordingly, when the cover 17 is open, the stacker 27 is arranged in the first position in normal printing.

Next, an operation of the stacker unit 53 having such a configuration will be described. When the cover 17 is open, the stacker 27 is normally arranged in the first position. When performing normal printing, for example, the stacker 27 is slid out to be in the extension state. On the other hand, when performing the label printing, the user presses down on the manipulation section 31a to switch the stacker 27 from the first position to the second position. At this time, by the pressing down manipulation of the manipulation lever 31, the rotation cam 62 which is included in the power transmission gear mechanism 54 rotates, and thus, the support shaft 57 installed to the extension section 62a of the rotation cam 62 moves upward along the first hole section 58a from the position inside of the second hole section 58b, and the pinion 63 of the drive side is rotated according to the upward movement of the support shaft 57 while being engaged with the rack 71.

As the support shaft 57 rotates by the rotation of the pinion 63 of the drive side, the pinion 63 of the other end part (driven side) of the support shaft 57 rotates while being engaged with the rack 74. Accordingly, the pair of pinions 63 moves up while being engaged with the racks 71 and 74, and the support shaft 57 is raised at the axial opposite sides thereof. By the upward movement of the support shaft 57, the base end part of the stacker 27 moves up. As a result, the stacker 27 rotates in the counterclockwise direction in FIG. 11 (clockwise direction in FIG. 9) centering around the front end part of the stacker 27 (the coupling position of the support hole 77 and the coupling protrusion 76), and then, is arranged in the second position shown in FIG. 12 (two-dotted line in FIG. 9).

In the rotation process of the stacker 27, the base end part (second end part) which is the force acting point in which force from the manipulation lever 31 is applied to the stacker 27 is disposed so as to be spaced away from the front end part (the coupling position of the support hole 77 and the coupling protrusion 76) which is the supporting point. Since the force acting point is disposed so as to be spaced away from the supporting point, the stacker 27 can be switched from the first position to the second position with a relatively small force. That is, when rotating the stacker 27, load which is applied to the end part of the drive side of the support shaft 57 becomes relatively small. Accordingly, the rotation of the pinion 63 at one end part of the support shaft 57 is rapidly transmitted to the pinion 63 at the other end part of the support shaft 57. Thus, the pair of pinions 63 which is fixed to the axial opposite sides of the support shaft 57 moves up while maintaining approximately the same height, and thus, the support shaft 57 may be raised while horizontally maintaining the base end part thereof.

For example, in the related art (for example, JP-A-2007-45574 (for example, FIGS. 11 to 13 or the like), or the like) in which a force acting point of the stacker is located close to a supporting point thereof, it is necessary to apply a relatively large force to the force acting point, and thus, a relatively large load is applied to the support shaft. Accordingly, in the process that the rotation of the pinion of the one end part of the support shaft is transmitted to the pinion of the other end part through the rotation of the support shaft, the support shaft is twisted, and thus, the rotation of the pinion of the other end part may become slow. In this case, the heights of the pinions become different at the right and left sides, and thus, the stacker 27 may be inclined at the right and left sides thereof in the posture changing process. In this case, it is necessary for the support shaft to be made of metal for securing stiffness, or it is necessary to install two sets of power transmission gear mechanisms for transmitting a manipulation force of the manipulation lever. However, according to the stacker unit 53 in this embodiment, since the force acting point of the stacker 27 is sufficiently distant from the supporting point and the load applied to the support shaft 57 becomes small when the stacker 27 rotates, the manipulation of the manipulation lever 31 is convenient, and the support shaft 57 made of resin can be used. Moreover, even though the resin support shaft 57 is used, the stacker 27 is prevented from being inclined at right and left sides thereof when the stacker 27 changes its position.

As described above, according to the embodiments of the invention, the following effects may be obtained.

(1) There are provided the first support unit (the support sections 75, the extension sections 78, the extension plate sections 33b and the like) which supports the front end part (first end part) of the stacker 27 so that it is able to rotate through the coupling of the coupling protrusion 76 and the support 77, and the second support unit (elevating mechanism including the support shaft 57, the guide holes 58, the pinions 63 and the racks 71 and 74 and the like) which moves the base end part of the stacker 27 upward and downward while supporting the base end part (second end part) of the stacker 27. Further, the second support unit (elevating mechanism) includes the support shaft 57 which is inserted in the base end part of the stacker 27, the guide holes 58 which guide the support shaft 57 in the movement path which is displaceable upward and downward, and the pinions 63 fixed to the axial opposite sides of the support shaft 57 with the stacker 27 being interposed therebetween, and the racks 71 and 74 formed along the guide holes 58 to be capable of being engaged with the pinions 63. Accordingly, the stacker 27 rotates as the base end part thereof moves upward and downward centering around the front end part thereof, and accordingly, is displaced between the first position and the second position. Thus, as compared with the stacker unit in JP-A-2007-45574 (for example, FIGS. 11 to 13 or the like) in which the supporting point and the force acting point are located close to the base end side of the stacker and force is applied to the force acting point of the base end part centering around the supporting point of the base end part to thereby raise the front end part (free end part) of the stacker, in this embodiment, the movement range when changing the position of the stacker 27 is narrow. Accordingly, the printer 11 can be prevented from being of a large size due to the wide movement range of the stacker 27.

(2) Further, as compared with the stacker unit in JP-A-2007-45574 (for example, FIGS. 11 to 13 or the like), in the stacker unit 53 according to this embodiment, since the supporting point located in the front end part of the stacker 27 and the force acting point located in the base end part thereof are sufficiently spaced from each other, the force applied to the force acting point of the base end part is relatively small when the stacker 27 rotates centering around the front end part. Accordingly, the load applied to the support shaft 57 is relatively small when changing the posture of the stacker 27. For example, if the load applied to the support shaft is relatively large as in JP-A-2007-45574 (for example, FIGS. 11 to 13 or the like), when the drive force is input from one side of the axial opposite sides of the support shaft, the support shaft is twisted and the rotation of the pinion of the driven side becomes slower than the rotation of the pinion of the drive side, and thus, the heights at the axial opposite sides of the support shaft become different, thereby causing a problem that the stacker is inclined in the right and left direction when changing its posture. In this case, it is necessary for the support shaft to be made of a metal shaft having a high stiffness. However, according to this embodiment, since the load applied to the support shaft 57 is small, its twisting is hardly generated even though the resin support shaft 57 is used. Further, since the support shaft 57 is displaced upward and downward while maintaining the same height in the axial opposite sides (arrangement positions of the pair of pinions 63), the stacker 27 can be prevented from being inclined in the right and left direction when changing its position.

(3) The pinions 63 are installed to be displaced in the rotational radius direction thereof in the rotation cams (rotational body), and the support shaft 57 to which the pinions 63 are fixed at the opposite sides is inserted into the elongated hole 79 (cut-out section) which is formed in the base end part of the stacker 27 in the state of being inserted in the guide hole 58. Further, the guide hole 58 has the horizontal U-shape which includes the first hole section 58a which extends vertically, the second hole section 58b which extends from the lower end part of the first hole section 58a in the direction (horizontal direction) crossing the first hole section 58a, and the third hole section 58c which extends from the upper end part thereof of the first hole section 58a in the direction (horizontal direction) crossing the first hole section 58a. Accordingly, when the stacker 27 is arranged in the second position, the support shaft 57 receives the weight of the stacker 27 in the lower wall surface 58e of the third hole section 58c, and thus, the support shaft 57 can be prevented from the downward movement, thereby maintaining the stacker 27 in the second position. Thus, it is not necessary to install a posture maintaining mechanism (biasing mechanism using a spring) for maintaining the stacker in the second position, as in JP-A-2007-45574 (for example, FIGS. 11 to 13 or the like). Further, when the stacker 27 is arranged in the first position, the support shaft 57 receives the load due to the weight of the printing paper P applied to the downstream side in the transport direction from the supporting point of the stacker 27, in the upper wall surface 58d of the second hole section 58b, and thus, the upward movement of the support shaft 57 can be regulated, thereby maintaining the stacker 27 in the first position. Further, since the posture maintaining mechanism using an elastic force of the spring is not required, it is not necessary to manipulate the manipulation lever 31 against the elastic force of the spring, and thus, the manipulation lever 31 can be prevented from being inconveniently manipulated due to the spring when changing the position of the stacker 27. In addition, sound or the like due to the elastic force of the spring is hardly generated, and thus, silence can be secured during the manipulation of the manipulation lever 31.

(4) In the inner circumferential edge of the elongated hole 79 which is formed in the base end part of the stacker 27 is formed the locking recess 80 which is recessed in the direction crossing the extending direction of the elongated hole 79. Accordingly, in the state that the stacker 27 is arranged in the second position, the support shaft 57 is positioned in the state of being locked in the locking recess 80. As a result, in the state that the stacker 27 is arranged in the second position, the movement of the support shaft 57, which is located in the third hole section 58c, toward the first hole section 58a can be prevented. Accordingly, the stacker 27 can be effectively maintained in the second position.

(5) The support hole 77 is an elongated hole which extends in the downward direction crossing (here, perpendicular to) the direction toward the base end part of the stacker 27, and the coupling protrusion 76 is able to relatively move inside of the support hole 77. Accordingly, if the front end part of the stacker 27 is raised, the gap between the front end part of the stacker 27 and the extension plate section 33b of the lower housing 33 may be widened. Thus, the user may secure the gap, for insertion of his or her fingers, between the front end part of the stacker 27 and the extension plate section 33b, in order to slide the stacker 27.

(6) The extension wall sections 81 and 82 (wall sections) and the extension wall section 83 (wall section) extend from the opposite surfaces of the stacker 27 and the extension plate section 33b in the direction in which the front end part of the stacker 27 moves toward and away from the extension plate section 33b by the coupling of the support hole 77 and the coupling protrusion 76. Further, in the state that the stacker 27 is in the first position, the respective front end parts of the extension wall sections 81 and 82 and the extension wall section 83 partly overlap in the direction of moving toward and away from each other. Accordingly, even though the front end part of the stacker 27 is displaced upward with respect to the extension plate section 33b to widen the gap therebetween, alien substances can be effectively prevented from entering inside of the extension wall sections 81 to 83.

(7) The manipulation force transmitted to the tooth section 31b which is formed on the end edge part of the manipulation lever 31 is speed-increased through the power transmission gear mechanism 54 including at least one gear (gears 59, 60 and 70 and the like in this embodiment) and transmitted to the support shaft 57, and thus, the movement amount of the support shaft 57 can be significantly secured compared with the manipulation amount of the manipulation lever 31. As the guide hole 58 has the horizontal U-shape, the movement amount of the support shaft 57 when changing the position of the stacker 27 corresponds to the sum of a displacement amount (the length of the first hole section 58a) necessary for the upward and downward displacement of the support shaft 57 and the amount of horizontal displacements in the second hole section 58b and the third hole section 58c, and the power transmission gear mechanism 54 is a speed-increasing mechanism, and thus, the amount of manipulation of the manipulation lever 31 when changing the position of the stacker 27 can be reduced. Further, as the power transmission gear mechanism 54 is the speed-increasing mechanism, the manipulation of the manipulation lever 31 tends to be inconvenient. However, since a distance between the supporting point and the force acting point is sufficiently secured, the force applied to the force acting point can be relatively small. Accordingly, the manipulation of the manipulation lever 31 can be convenient, even though the manipulation force is speed-increased through the power transmission gear mechanism 54 and transmitted to the support shaft 57.

(8) The horizontal U-shaped guide hole 58 is arranged to be convex toward the manipulation lever 31 (or rotation center of the manipulation lever 31). As a result, with respect to the position of the support shaft 57 when the stacker 27 is arranged in each position, a movement space in which the support shaft 57 moves upward and downward may be arranged in a side of the manipulation lever (front end part of the stacker 27) in the transport direction.

If the guide hole is arranged to be convex toward an opposite side to the manipulation lever, the arrangement position of the stacker 27 should be shifted toward the front side (front end part side) so that the movement space when the support shaft moves upward and downward does not interfere with the components such as a platen 43 or a waste ink tank 50. This causes the printer to be of a large size in a front and rear direction thereof. However, in this embodiment, since the guide hole 58 is arranged to be convex toward the manipulation lever 31, the movement space when the support shaft 57 moves upward and downward can use a space underneath the stacker 27. Accordingly, the stacker 27 can be arranged as close to the platen 43 as possible, and the printer 11 can be prevented from being of a large size in the front and rear direction. Further, the pinion 63 (or the support shaft 57) passes through a path directing toward the rotation center of the manipulation lever 31 from the rotation center of the rotation cam 62. Accordingly, a circular arc direction of a rotation trace of the pinion 63 (or the support shaft 57) becomes convex toward the same direction as in the guide hole 58. Thus, the displacement amount (for example, the length of the guide groove 62b) for relatively displacing the pinion 63 (or the support shaft 57) which moves along the horizontal U-shaped guide hole 58 in the rotational radius direction of the rotation cam 62 becomes small, and the rotation cam 62 can be prevented from being of a large size.

The embodiment is not limited to the above description, and may be modified as follows.

A configuration which does not include the power transmission gear mechanism may be employed. For example, in the end edge part of the manipulation lever opposite to the manipulation section with the rotation center being interposed therebetween, the support shaft (and pinion) may be inserted to be displaced in the rotational radius direction of the manipulation lever. Accordingly, if the manipulation lever is manipulated, the support shaft which is inserted in the end edge part thereof moves along the horizontal U-shaped guide hole 58, and the pinions which are fixed to the opposite end parts of the support shaft are engaged with the racks which are formed along the guide hole.

The front end part (first end part) of the stacker may be supported so that it is able to rotate with respect to the extension plate section 33b, and the front end part of the stacker and the extension plate section 33b may not move toward and away from each other. For example, the coupling protrusion may have a cylindrical shape, and the support hole may have a circular shape. Here, the front end part of the stacker may be supported so that it is able to rotate. Further, if an arm of the support unit is lengthened, a gap for insertion of fingers may be secured between the front end part of the stacker and the extension plate section 33b.

The guide hole is not limited to the horizontal U-shape. For example, a Z-shape may be employed. Further, for example, an L-shape or a reverse L-shape may be employed. In this case, only one of the second hole section and the third hole section included in the horizontal U-shaped guide hole 58 is included in the guide hole of the L shape or the reverse L shape, and the regulating surface for regulating the movement of the support shaft 57 for maintaining the stacker in the arranged position becomes one. In this case, the stacker may be maintained in one position (posture) without using a spring. Further, maintenance of the position of the support shaft 57 which cannot be regulated by the regulating surface may be elastically biased by a spring. In this way, it is sufficient that there is at least one regulating surface of the guide means. In addition, the guide hole may have a hole shape which extends upward and downward, instead of the horizontal U-shape. In this case, maintenance in two positions of the stacker 27 may be elastically biased by a spring.

In the above described embodiment, the support hole 77 is installed in the stacker 27 and the coupling protrusion is installed in the first support unit (extension plate section 33b), but they may be configured in the opposite way. That is, the coupling protrusion may be installed in the stacker 27 and the support hole may be installed in the first support unit (extension plate section 33b). Here, the gap between the front end part of the stacker and the extension plate section 33b may be widened for insertion of fingers in order to slide the stacker 27.

In the above described embodiment, in addition to the locking recess 80, or instead of the locking recess 80, a locking recess in which the support shaft 57 is locked when the stacker 27 is arranged in the first position may be installed in the inner circumferential edge of the elongated hole 79. This locking recess may be formed to be recessed downward in the inner circumferential edge of the elongated hole 79. According to such a configuration, in the state that the stacker is in the first position, the support shaft 57 may be positioned in the state of being locked in the locking recess, thereby maintaining the stacker in the first position.

The guide means which guides the support shaft 57 is not limited to the guide hole. For example, a recess having an inner circumferential surface of a horizontal U-shape may be employed. In this case, if the pinion is biased by a bias means such as a spring toward an outer side of the rotation radius thereof with respect to the rotation cam, the support shaft 57 may move along the inner circumferential surface of the recess.

In the above described embodiment, a configuration that the pinions and the racks are removed may be employed. For example, the end edge opposite to the manipulation section of the manipulation lever is in contact or coupled with the base end part of the stacker. In this state, if the manipulation lever is manipulated up and down, as the base end part of the stacker is pressed up or down according to a leverage principle, the position of the stacker may be changed. In this case, the posture in each position of the stacker may be maintained by installing a posture maintaining mechanism using a spring. With such a configuration, the supporting point and the force acting point of the stacker are sufficiently spaced from each other, and thus, the movement range when changing the position of the stacker may be small, thereby achieving a printer with a small size.

The cut out section for inserting the support shaft into the second end part (base end part) of the stacker is not limited to the elongated hole 79, but a recess which extends along the rotation radius direction of the stacker 27 may be employed. It is preferable that the recess has a shape which is recessed as a U shape along its lengthwise direction.

In the above described embodiment, instead of performing the position changing (posture changing) of the stacker 27 using the manipulation force of the manipulation lever 31, a position changing of the stacker 27 may be performed due to power of an actuator such as an electric motor which is operated by manipulating a manipulation switch. In this case, for example, a power transmission mechanism in which a gear rotating by the power of the actuator is engaged with the gear 70 of the rotation cam 62, may be employed. In such a configuration, if the stacker 27 moves the second end part thereof upward and downward centering around the first end part thereof, since force applied to the second end part which is the force acting point becomes relatively small, load applied to the electric motor when changing the position of the stacker may be reduced.

The platen is not limited to a plate shape. A cylindrical platen may be used.

The stacker is not limited to the horizontal state in the second position. If the platen is inclined with respect to the horizontal state, an inclined posture in which a straight line transport path can be formed with respect to an inclined transport surface of the platen becomes the second posture. Further, in the case of the cylindrical platen, the stacker may be arranged in the second posture so that a guide surface is located on an extension in a tangential direction in a recording position of the platen.

The recording apparatus is not limited to the ink jet type. The recording apparatus may include a dot impact printer, a laser printer or the like. Further, it is not limited to a serial printer, and may be applied to a line printer or a page printer. Moreover, the recording apparatus is not limited to the multi-functional printer (complex machine), and may be a printer which does not include the scanner unit.

What is claimed is:

1. A recording apparatus including a transport unit which transports a recording medium and a recording unit which performs recording on the recording medium transported to a recording position, the recording apparatus comprising:
a stacker which is configured to be displaced between a first posture for stacking the recording medium in an inclined state that a first end part which is distant from the recording position in a transport direction is located above a second end part which is near thereto, and a second posture for forming a transporting path of a straight line along which the recording medium is able to be transported toward the recording position;
a first support unit which supports the first end part of the stacker to be able to rotate; and
a second support unit which moves the second end part of the stacker upward and downward while supporting the second end part of the stacker to rotate the stacker centering around the first end part when the stacker is displaced between the first posture and the second posture.

2. The recording apparatus according to claim 1,
wherein the second support unit includes a support shaft which is inserted in a cut-out section which is provided in the second end part of the stacker to be relatively displaced in a rotational radius direction of the stacker, and a guide unit which guides the support shaft in a movement path in which the support shaft is displaced upward and downward,
wherein the guide unit includes, in the state that the stacker is arranged in at least one posture of the first posture and the second posture, a regulating surface which regulates one movement, by which the stacker is able to be changed to the other posture thereof, among the upward and downward movements of the support shaft.

3. The recording apparatus according to claim 2,
wherein a horizontal U-shaped guide hole is provided as the guide unit,
wherein the support shaft is movably inserted into one pair of the guide holes in the opposite sides thereof with the stacker being interposed therebetween, and a pair of pinions which is engaged with a pair of racks installed along the one pair of guide holes is fixedly installed to the opposite sides of the support shaft, and
wherein one side of the opposite sides of the support shaft to which the one pair of pinions is installed is a drive side to which power for moving the support shaft upward and downward is input, and the other side thereof is a driven side which moves upward and downward, as the pinion which is installed on an axial opposite side of the support shaft is rotated by rotation of the other pinion of the drive side.

4. The recording apparatus according to claim 3, further comprising a power transmission mechanism including at least one gear which is engaged with a tooth section formed in an end edge of a manipulation lever, wherein the power transmission mechanism increases the speed of the power transmitted to the tooth section on the basis of a manipulation force of the manipulation lever and transmits the speed increased power to the support shaft.

5. The recording apparatus according to claim 4, wherein a locking recess which is recessed in a direction crossing an extending direction of the cut-out section is formed in an inner circumferential edge of the cut-out section, and in the state that the stacker is arranged in at least one of the first posture and the second posture, the support shaft is positioned in the state of being locked to the locking recess.

6. The recording apparatus according to claim 5, wherein the stacker has a slide configuration of a plurality of stages, which is capable of being extended, and the first end part is supported to relatively move toward and away from the first support unit and to be able to rotate.

7. The recording apparatus according to claim 6, wherein a pair of wall sections extends from opposite surfaces of the stacker and the first support unit, and in the state that the first end part is located adjacent to the first support unit, front end parts of the one pair of wall sections partly overlap with each other to move toward and away from each other.

8. The recording apparatus according to claim 7, wherein the horizontal U-shaped guide hole is arranged to be convex toward the manipulation lever, and the pinions are installed to be displaced in a rotation displacement direction in a position in which the pinions are deviated toward the manipulation lever from a rotation center of a rotational body which forms the power transmission mechanism with respect to the rotational body while changing the posture of the stacker.
